(19) United States
(12) Patent Application Publication
(10) Pub. No.: US 2025/0257286 A1
(43) Pub. Date: Aug. 14, 2025

(54) CLEANING COMPOSITIONS AND METHODS OF USE THEREOF

(71) Applicant: Fujifilm Electronic Materials U.S.A, Inc., N. Kingstown, RI (US)

(72) Inventors: Wei Li, Queen Creek, AZ (US); Bin Hu, Chandler, AZ (US); Eric Turner, Phoenix, AZ (US); Changhong Wu, Mesa, AZ (US); Alexei P. Leonov, Chandler, AZ (US); Hyosang Lee, Chandler, AZ (US)

(21) Appl. No.: 19/047,786

(22) Filed: Feb. 7, 2025

Related U.S. Application Data
(60) Provisional application No. 63/551,504, filed on Feb. 8, 2024.

(51) Int. Cl. C11D 1/00; C11D 3/00; C11D 3/20; C11D 3/33

(52) U.S. Cl. CPC C11D 1/008; C11D 3/0047; C11D 3/2082; C11D 3/33; C11D 2111/22

(57) ABSTRACT

The present disclosure relates to cleaning compositions that can be used to clean semiconductor substrates. These cleaning compositions can be used to remove defects arising from previous processing steps on these semiconductor substrates. These cleaning compositions can remove the defects/contaminants from the semiconductor substrates and thereby make the substrates appropriate for further processing. Such cleaning compositions can include use of a polisher rinse composition, use of a post-CMP composition, or use of a combination of the polisher rinse composition and the post-CMP composition.

### CROSS-REFERENCE TO RELATED APPLICATION

The present application claims priority to U.S. Provisional Application Ser. No. 63/551,504, filed on Feb. 8, 2024, the contents of which are hereby incorporated by reference in their entirety.

### FIELD

The present disclosure relates to cleaning compositions for use with semiconductor substrates.

### BACKGROUND

The semiconductor industry is continually driven to improve chip performance by further miniaturization of devices through process and integration innovations. Chemical Mechanical Polishing/Planarization (CMP) is a powerful technology as it makes many complex integration schemes at the transistor level possible, thereby facilitating increased chip density.

CMP is a process used to planarize/flatten a wafer surface by removing material using abrasion-based physical processes concurrently with surface-based chemical reactions. In general, a CMP process involves applying CMP slurry (e.g., an aqueous chemical formulation) to a wafer surface while contacting the wafer surface with a polishing pad and moving the polishing pad in relation to the wafer. CMP slurries typically include an abrasive component and dissolved chemical components, which can vary significantly depending upon the materials present on the wafer (e.g., metals, metal oxides, metal nitrides, dielectric materials such as silicon oxide, silicon nitride, etc.) that will be interacting with the slurry and the polishing pad during the CMP process.

After CMP processing, the polished wafers are usually rinsed with deionized water, commonly referred to as high pressure rinsing, to terminate any chemical reactions and remove water miscible components (e.g., pH adjusters, organic components, and/or oxidants) and byproducts (e.g., ionic metals removed during CMP or pad debris) left on the polished wafer after the CMP processing step. However, even after the deionized water rinse, a variety of contaminants may remain on the surface of the polished wafer. Contaminants may include, for example, particulate abrasive from the CMP slurry, organic residue from the pad or slurry components, and material removed from the wafer during the CMP process. If left on the surface of the polished wafer, these contaminants may lead to failures during further wafer processing steps and/or to diminished device performance. Thus, the contaminants need to be effectively removed so that the polished wafer may predictably undergo further processing and/or to achieve optimal device performance.

Commonly, the process of removing these post-polishing contaminants or residues on the wafer surface after CMP (and the deionized water rinse) is performed with post-CMP (P-CMP) cleaning solutions. Post-CMP cleaning solutions are applied to the polished wafer using a brush scrubber or a spin rinse dry apparatus (i.e., the wafer is removed from the CMP polishing tool and transferred to a different apparatus for post-CMP cleaning). Nonetheless, with the complex integration schemes and scaling down of size in advanced node semiconductor manufacturing, it has been increasingly noticed that traditional post-CMP cleaning is insufficient to adequately remove contaminants from the polished wafer.

### SUMMARY

In semiconductor chip manufacturing, defectivity on the wafer surface is the key to the yield of the wafers which determines the top and bottom line of chip companies globally. A typical wafer goes through about 1000 processes before chips are made and the individual dies are cut from the wafer. At each of these processes, the defectivity is monitored pre- and post-process. CMP is an important step in chip manufacturing. However, the CMP steps introduce a significant amount of defects to the wafers. As mentioned above, the conventional workflow, shown in FIG. 1, has proven inadequate at removing contaminants in advanced node semiconductor manufacturing. The present disclosure relates to polisher rinse compositions and post-CMP compositions, as well as cleaning methods for processing a substrate using both a polisher rinse composition and a post-CMP composition. A general workflow for a method using polisher rinse compositions according to this disclosure and post-CMP compositions according to this disclosure is shown in FIG. 2 and will be described in detail later in this disclosure.

The present disclosure relates to cleaning compositions that can be used to clean semiconductor substrates. For example, these cleaning compositions can be used to remove defects arising from previous processing steps, such as CMP, on these semiconductor substrates. In particular, these cleaning compositions can remove the defects/contaminants from the semiconductor substrates and thereby make the substrates appropriate for further processing. The cleaning compositions described herein generally contain an organic acid and an anionic polymer and a nonionic surfactant, and have any useful pH. In some embodiments, the cleaning composition can have an acidic pH (e.g., a pH in the 0.1 to 6.5 range) or other pH ranges described herein. The cleaning compositions can include a concentrated composition, a polisher rinse composition, or a post-CMP composition.

In one aspect, the present disclosure relates to polisher rinse compositions and post-CMP compositions and methods, which not only reduce wafer defects but can also provide various other electrochemical attributes that are critical for chip manufacturing.

In another aspect, the present disclosure features a cleaning composition that includes at least one first organic acid; at least one anionic polymer; at least one nonionic surfactant; and water. In some embodiments, the composition has an acidic pH or other pH ranges described herein.

In another aspect, the present disclosure features a cleaning composition that includes at least one organic acid; at least one anionic polymer including poly(4-styrenylsulfonic) acid (PSSA), polyacrylic acid (PAA), poly(vinylphosphonic acid) (PVPA), poly(2-acrylamido-2-methyl-1-propanesulfonic acid), poly(N-vinylacetamide) (PNVA), anionic poly(methyl methacrylate) (PMMA), anionic polyacrylamide (PAM), 2-acrylamido-2-methyl-1-propanesulfonic acid-acrylic acid copolymer, poly(4-styrenesulfonic acid-co-acrylic acid-co-vinylphosphonic acid) terpolymer, or a mixture thereof, at least one nonionic surfactant; and water. In some embodiments, the composition has a pH of from about 0.1 to about 6.5 or other pH ranges described herein.

In another aspect, the present disclosure features a cleaning composition that includes at least one carboxylic acid; at least one amino acid; at least one anionic polymer; at least one nonionic surfactant; an optional dienoic acid; an optional pH adjuster; and water. In some embodiments, the composition has an acidic pH or other pH ranges described herein.

In another aspect, the present disclosure features a cleaning composition that includes at least one chelating agent; at least one corrosion inhibitor; at least one anionic polymer; at least one nonionic surfactant; at least one biocide; an optional pH adjuster; and water. In some embodiments, the composition has an acidic pH or other pH ranges described herein.

In another aspect, the present disclosure features a method for cleaning a wafer surface, the method including contacting a wafer having a surface comprising SiN, SiC, TiN, W, Ru, Mo, TEOS, Cu, TaN, Co, or p-Si with the cleaning composition described herein, the polisher rinse composition described herein, and/or the post-CMP composition described herein.

In another aspect, the present disclosure features a method for cleaning a substrate, the method including contacting a substrate with the cleaning composition described herein, the polisher rinse composition described herein, and/or the post-CMP composition described herein.

In another aspect, the present disclosure features a method for cleaning a substrate, the method including: buffing a polished substrate with a polisher rinse composition described herein to provide a rinse polished substrate, wherein the polisher rinse composition comprising a plurality of components; and cleaning the rinse polished substrate with a post-CMP composition described herein. In some embodiments, the post-CMP composition includes one or more components of the polisher rinse composition.

This summary is provided to introduce a selection of concepts that are further described below in the detailed description. This summary is not intended to identify key or essential features of the claimed subject matter, nor is it intended to be used as an aid in limiting the scope of the claimed subject matter.

As defined herein, unless otherwise noted, all percentages expressed should be understood to be percentages by weight to the total weight of the cleaning composition.

Other aspects and advantages of the claimed subject matter will be apparent from the following description and the appended claims.

### DESCRIPTION OF DRAWINGS

FIG. 1 is a workflow diagram for a conventional CMP and post-CMP clean process.

FIG. 2 is a workflow diagram for an example of CMP and a post-CMP clean process that incorporates a polisher rinse composition described herein and a post-CMP composition described herein after the CMP process.

FIG. 3 is a graph showing relative total defect counts on silicon (Si) after post-CMP cleaning.

FIG. 4 is a graph showing relative total defect counts on polysilicon (p-Si) after post-CMP cleaning.

FIG. 5 shows wafer defect maps (top) and frequency of various defect modes (bottom) on polysilicon (p-Si) after post-CMP cleaning.

FIG. 6 is a graph showing relative total defect counts on TEOS (a form of silicon oxide) or SiN (silicon nitride) after post-CMP cleaning.

### DETAILED DESCRIPTION

Embodiments disclosed herein relate generally to cleaning compositions and methods of using said compositions to clean substrates (e.g., semiconductor substrates such as wafers). In one embodiment, the cleaning compositions described herein are effective as a post-CMP composition. For example, and without limitation, the post-CMP compositions described herein can provide improved defectivity, as compared to other comparative post-CMP compositions.

In another embodiment, the cleaning compositions described herein are effective as both a polisher rinse composition and a post-CMP composition. In particular, a polisher rinse composition can be used during a buffing (or rinse polishing) process, and a post-CMP composition can be used during a post-CMP cleaning process. Without wishing to be bound by theory, it is believed that there is a surprising and unexpected synergism in using a polisher rinse composition and a post-CMP composition having comparable components but of differing concentrations. Such components can include any described herein for a cleaning composition. For example, and without limitation, using a post-CMP composition that is a diluted form of the polisher rinse composition (or using a polisher rinse composition that is a concentrated form of the post-CMP composition) can provide significantly lower defectivity, as compared to a process that uses no polisher rinse composition or that uses deionized water as a polisher rinse composition.

The cleaning compositions herein can be provided in any useful form. For example, and without limitation, the cleaning composition can be provided as a concentrated composition, a polisher rinse composition, and/or a post-CMP composition. In particular, the polisher rinse compositions can be used to clean substrates directly after a CMP process (e.g., on the polishing tool itself without removing the polished substrate from the polishing tool), and these polisher rinse compositions are sometimes referred to herein as “rinse polish”, “buff chemical”, or “rinse” compositions. In addition, the polisher rinse compositions described herein can also find use in removing residue and/or contaminants from a substrate surface after an etching process, after an ashing process, after a plating process, or even in a conventional post-CMP cleaning process (i.e., one that takes place using a separate apparatus from the polishing tool).

As defined herein, residue and/or contaminants can include components present in a CMP composition that has been used to polish the substrate to be cleaned (e.g., abrasives, molecular components, polymers, acids, bases, salts, surfactants, etc.), compounds produced during the CMP process as a result of chemical reactions between the substrate and the CMP composition and/or between components of the CMP composition, polishing pad debris particles (e.g., particles of a polymeric pad), polishing byproducts, organic or inorganic residues (e.g., those from a CMP slurry or CMP pad), substrate (or wafer) particles liberated during the CMP process, and/or any other removable materials that are known to deposit on a substrate after a CMP process.

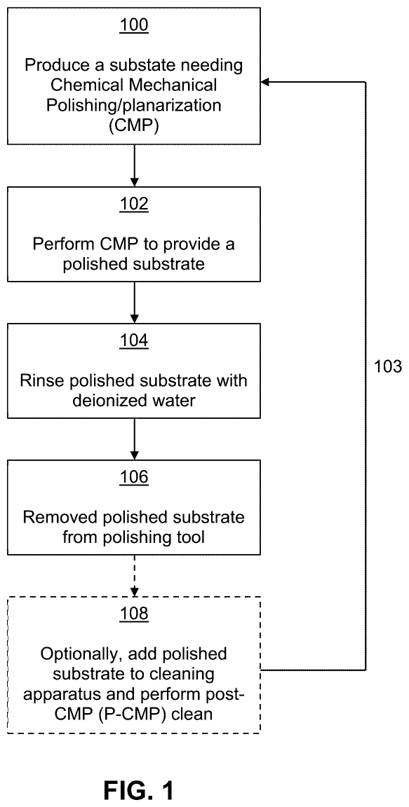

FIG. 1 is a workflow diagram for a conventional CMP and post-CMP clean process. The CMP step is typically performed in a polishing tool, which includes at least a polishing chamber (which includes polishing pads, polishing platens, and polishing heads), a cleaning chamber, and a drying chamber. In step 100, a substrate needing CMP is produced, e.g., after lithography and/or a material is deposited on the substrate. For example, the material that is deposited can be a metal or a dielectric material, and the substrate can be a silicon wafer. In step 102, chemical mechanical planarization (CMP) is performed in a polishing chamber of a polishing tool. For example, a wafer can be delivered to a polishing head in the polishing chamber and attached to the polishing head by vacuum before the CMP. The head can then bring the wafer to press onto a polishing pad, rotate the wafer, and apply an appropriate pressure to the wafer during CMP. CMP is performed in order to remove unnecessary deposited material and planarize the surface of the deposited material on the substrate. After the CMP, in step 104 the polished substrate (where “polished substrate” is defined as a substrate that has been polished using a CMP method) is rinsed with deionized (DI) water. This step is commonly believed to assist in washing/cleaning debris and residue left on the polished substrate and takes place in the polishing chamber of the polishing tool using milder polishing conditions (e.g., less downforce and rotational speed) directly after the polishing. However, without wishing to be bound by theory, it is believed that the drastic pH change from a CMP polishing composition (which can be highly acidic or highly alkaline) to DI water can cause some adverse chemistry to occur that can effectively cause a portion of the debris/residue to stick more tightly to the polished substrate surface. Subsequently, the now more tightly bound debris/residue are much more difficult to remove with a conventional post-CMP cleaning process once the polished substrate is removed from the polishing tool in step 106, transferred to a conventional post-CMP cleaning apparatus and cleaned in step 108. Optionally, after the conventional post-CMP cleaning in step 108, the polished substrate can be subjected to workflow 103 during which steps 100, 102, 104, 106, and 108 are repeated. If no further lithography/deposition and CMP is desired after step 108, the polished substrate can be used in a subsequent semiconductor manufacturing process.

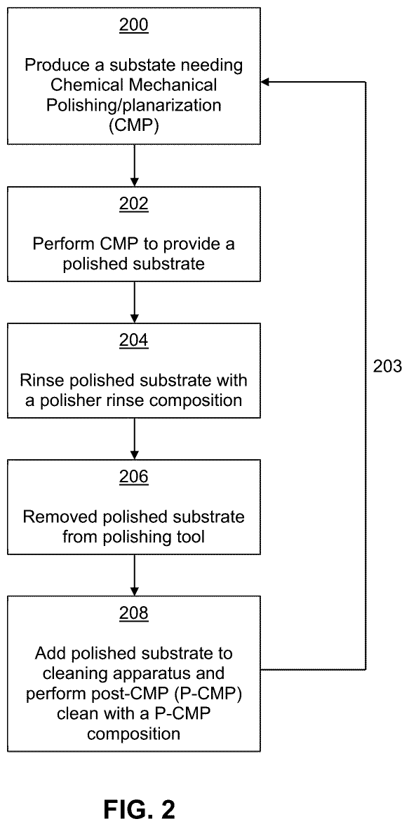

FIG. 2 is a workflow diagram for an example of a process of the present invention, which incorporates a polisher rinse composition described herein between the CMP process and an optional post-CMP process. In step 200, a substrate needing CMP is produced, e.g., after lithography and/or deposition of a material on the substrate. In step 202, chemical mechanical planarization (CMP) is performed in a polishing chamber of a polishing tool. After the CMP, in step 204, the polished substrate is rinsed with a polisher rinse composition as disclosed herein.

In some non-limiting embodiments, a brief (e.g., a few seconds or less) DI water rinse is applied to the polished substrate directly after CMP. This brief DI water rinse can purge the equipment lines, the pad, and the polished substrate of any remaining CMP polishing composition and wash away any large debris.

As mentioned herein, the process in step 204 is also referred to as a “buffing process” or a “rinse polishing process”. In some embodiments, the rinse in step 204 can be performed on the polished substrate while the polished substrate is still located in the polishing chamber of the polishing tool (e.g., attached to a polishing head in the polishing chamber and facing a polishing pad without removing the polished substrate from the polishing tool). In some embodiments, in step 204, the polisher rinse composition is applied to the polished substrate at the same time that the polishing pad is in contact with the polished substrate and moving in relation to the substrate (i.e., the polishing pad is being used as it would be during a CMP process). One of the main differences between a CMP step 202 and the rinse polish in step 204 is that the polisher rinse composition being applied to the substrate includes substantially no abrasive particles, or a much smaller amount of abrasive particles (detailed below), than a CMP slurry composition would include. Thus, the material removed from the polished substrate in step 204 is primarily the debris/residue from the polishing step and not the deposited substrate material that is intended to be maintained on the polished substrate.

In some embodiments, the polisher rinse composition used on the polished substrate has a difference in pH value that is no more than about ±3 (e.g., no more than about ±2.5, no more than about ±2, no more than about ±1.5, no more than about ±1, or no more than about ±0.5) from the pH value of the CMP composition used to polish the polished substrate. In some embodiments, the pH value of the polisher rinse composition can be acidic if the pH value of the CMP composition used to polish the substrate was acidic, or the pH value of the polisher rinse composition can be basic if the pH value of the CMP composition used to polish the substrate was basic. In some embodiments, the pH value of the polisher rinse composition can be substantially the same as the pH value of the CMP polishing slurry used to polish the polished substrate. Without being bound by theory, it is believed that the use of a similar pH value for the CMP polish composition and the polisher rinse composition can result in more effective removal of the debris/residue left behind on the polished substrate than using simply DI water as a rinse.

The rinse polished substrate is removed from the polishing tool in step 206 and transferred to a cleaning apparatus for a post-CMP cleaning in step 208. In step 208, the rinse polished substrate is post-CMP cleaned with a post-CMP composition as described herein. One of the main differences between the rinse polish in step 204 and the post-CMP in step 208 is that the polisher rinse composition being applied to the substrate includes a higher concentration of at least one component, than the post-CMP composition would include. In some embodiments, the polisher rinse composition and the post-CMP composition includes the same components or similar components but at differing concentrations, in which the post-CMP composition is a diluted form of the polisher rinse composition. Without being bound by theory, it is believed that the use of same or similar components for the polisher rinse composition and the post-CMP composition can result in more effective removal of the debris/residue left behind on the polished substrate than using mismatched compositions during the buffing and post-CMP processes.

The pH value of compositions may affect removal of defects. In some embodiments, the post-CMP composition used on the polished substrate has a difference in pH value that is no more than about ±3 (e.g., no more than about ±2.5, no more than about ±2, no more than about ±1.5, no more than about ±1, or no more than about ±0.5) from the pH value of the polisher rinse composition. In some embodiments, the post-CMP composition used on the polished substrate has a difference in pH value that is no more than about ±3 (e.g., no more than about ±2.5, no more than about ±2, no more than about ±1.5, no more than about ±1, or no more than about ±0.5) from the pH value of the CMP composition used to polish the polished substrate.

Optionally, after the post-CMP cleaning in step 208, the polished substrate can be subjected to workflow 203 during which steps 200, 202, 204, 206, and 208 are repeated. If no further deposition and CMP is desired after step 208, the polished substrate can be used in a subsequent semiconductor manufacturing process.

In one or more embodiments, a cleaning composition described herein includes: (1) at least one organic acid, (2) at least one anionic polymer, and (3) at least one nonionic surfactant. In one or more embodiments, a cleaning composition of the present disclosure can include from about 0.00001% to about 50% (e.g., from about 0.01% to about 5%) by weight of the at least one organic acid, from about 0.00001% to about 50% (e.g., from about 0.005% to about 10%) by weight of the at least one anionic polymer, from about 0.00001% to about 1% (e.g., from about 0.005% to about 1%) by weight of the at least one nonionic surfactant, and the remaining percent by weight (e.g., from about 60% to about 99.99% by weight) of solvent (e.g., deionized water). In some embodiments, the cleaning composition includes at least one pH adjuster. In some embodiments, the cleaning composition has an acidic pH. In some embodiments, the cleaning composition has a basic pH. In some embodiments, the cleaning composition has a neutral pH or near neutral pH.

In one or more embodiments, a cleaning composition described herein includes: (1) at least one first organic acid (e.g., a carboxylic acid or a polycarboxylic acid), (2) at least one second organic acid (e.g., an amino acid), (3) at least one anionic polymer, and (4) at least one nonionic surfactant. In one or more embodiments, a cleaning composition of the present disclosure can include from about 0.00001% to about 50% (e.g., from about 0.01% to about 5%) by weight of the at least one first organic acid, from about 0.00001% to about 50% (e.g., from about 0.01% to about 5%) by weight of the at least one second organic acid, from about 0.00001% to about 50% (e.g., from about 0.005% to about 10%) by weight of the at least one anionic polymer, from about 0.00001% to about 10% (e.g., from about 0.005% to about 1%) by weight of the at least one nonionic surfactant, and the remaining percent by weight (e.g., from about 60% to about 99.99% by weight) of solvent (e.g., deionized water). In some embodiments, the cleaning composition includes at least one pH adjuster. In some embodiments, the cleaning composition has an acidic pH. In some embodiments, the cleaning composition has a basic pH. In some embodiments, the cleaning composition has a neutral pH or near neutral pH.

In one or more embodiments, a cleaning composition described herein includes: (1) at least one chelating agent (e.g., a polycarboxylic acid), (2) at least one corrosion inhibitor (e.g., an amino acid), (3) at least one anionic polymer (e.g., any described herein), (4) at least one nonionic surfactant (e.g., a polysorbate), and (5) at least one biocide (e.g., an isothiazolinone). In one or more embodiments, a cleaning composition of the present disclosure can include from about 0.00001% to about 50% (e.g., from about 0.01% to about 5%) by weight of the at least one chelating agent, from about 0.00001% to about 50% (e.g., from about 0.01% to about 5%) by weight of the at least one corrosion inhibitor, from about 0.00001% to about 50% (e.g., from about 0.005% to about 10%) by weight of the at least one anionic polymer, from about 0.00001% to about 1% (e.g., from about 0.005% to about 1%) by weight of the at least one nonionic surfactant, from about 0.1 ppm to about 1000 ppm by weight of the at least one biocide, and the remaining percent by weight (e.g., from about 60% to about 99.99% by weight) of solvent (e.g., deionized water). In some embodiments, the cleaning composition includes at least one pH adjuster. In some embodiments, the cleaning composition has an acidic pH. In some embodiments, the cleaning composition has a basic pH. In some embodiments, the cleaning composition has a neutral pH or near neutral pH.

In one or more embodiments, the present disclosure provides for a concentrated cleaning composition that can be diluted with a solvent (e.g., water) to obtain a point-of-use (POU) composition by up to a factor of 5, or up to a factor of 10, or up to a factor of 20, or up to a factor of 50, or up to a factor of 100, or up to a factor or 200, or up to a factor of 400, or up to a factor of 500, or up to a factor of 800, or up to a factor of 1000. Such POU compositions can include a POU polisher rinse composition or a POU post-CMP composition. In some embodiments, the present disclosure provides a POU polisher rinse composition that can be used directly for washing substrate surfaces on a polishing tool. In some embodiments, the present disclosure provides a POU post-CMP composition that can be used directly for washing substrate surfaces on a post-CMP tool.

In one or more embodiments, a POU cleaning composition can include from about 0.00001% to about 5% by weight of at least one organic acid, from about 0.00001% to about 10% by weight of at least one anionic polymer, and from about 0.00001% to about 1% by weight of at least one nonionic surfactant. In one or more embodiments, a POU cleaning composition can include from about 0.00001% to about 25% by weight of at least one organic acid, from about 0.00001% to about 25% by weight of at least one anionic polymer, and from about 0.00001% to about 1% by weight of at least one nonionic surfactant.

In one or more embodiments, a POU polisher rinse composition can include from about 0.00001% to about 25% by weight of at least one organic acid, from about 0.00001% to about 25% by weight of at least one anionic polymer, and from about 0.00001% to about 1% by weight of at least one nonionic surfactant. In some embodiments, a POU polisher rinse composition can include at least about 0.00001% (e.g., at least about 0.00005%, at least about 0.0001%, at least about 0.0005%, at least about 0.001%, at least about 0.005%, at least about 0.01%, at least about 0.05%, at least about 0.1%, at least about 0.5%, or at least about 1%) to at most about 25% (e.g., at most about 20%, at most about 15%, at most about 10%, at most about 5%, at most about 1%, at most about 0.5%, or at most about 0.1%) by weight of at least one organic acid; at least about 0.00001% (e.g., at least about 0.00005%, at least about 0.0001%, at least about 0.0005%, at least about 0.001%, at least about 0.005%, at least about 0.01%, at least about 0.05%, at least about 0.1%, at least about 0.5%, or at least about 1%) to at most 25% (e.g., at most about 20%, at most about 15%, at most about 10%, at most about 5%, at most about 1%, at most about 0.5%, or at most about 0.1%) by weight of at least one anionic polymer; and at least about 0.00001% (e.g., at least about 0.00005%, at least about 0.0001%, at least about 0.0005%, at least about 0.001%, at least about 0.005%, at least about 0.01%, at least about 0.05%, at least about 0.1%, or at least about 0.5%) to at most about 1% (e.g., at most about 0.9%, at most about 0.8%, at most about 0.7%, at most about 0.6%, at most about 0.5%, at most about 0.4%, at most about 0.3%, at most about 0.2%, at most about 0.1%, at most about 0.05%, at most about 0.02%, or at most about 0.01%) by weight of at least one nonionic surfactant.

In one or more embodiments, a POU post-CMP composition can include from about 0.00001% to about 1% by weight of at least one organic acid, from about 0.00001% to about 1% by weight of at least one anionic polymer, and from about 0.00001% to about 0.05% by weight of at least one nonionic surfactant. In some embodiments, a POU post-CMP composition can include at least about 0.00001% (e.g., at least about 0.00005%, at least about 0.0001%, at least about 0.0005%, at least about 0.001%, at least about 0.005%, at least about 0.01%, at least about 0.05%, at least about 0.1%, or at least about 0.5%) to at most about 1% (e.g., at most about 0.9%, at most about 0.8%, at most about 0.7%, at most about 0.6%, at most about 0.5%, at most about 0.4%, at most about 0.3%, at most about 0.2%, at most about 0.1%, at most about 0.05%, at most about 0.02%, or at most about 0.01%) by weight of at least one organic acid; at least about 0.00001% (e.g., at least about 0.00005%, at least about 0.0001%, at least about 0.0005%, at least about 0.001%, at least about 0.005%, at least about 0.01%, at least about 0.05%, at least about 0.1%, or at least about 0.5%) to at most 1% (e.g., at most about 0.9%, at most about 0.8%, at most about 0.7%, at most about 0.6%, at most about 0.5%, at most about 0.4%, at most about 0.3%, at most about 0.2%, at most about 0.1%, at most about 0.05%, at most about 0.02%, or at most about 0.01%) by weight of at least one anionic polymer; and at least about 0.00001% (e.g., at least about 0.00005%, at least about 0.0001%, at least about 0.0005%, at least about 0.001%, at least about 0.005%, at least about 0.01%, at least about 0.05%, at least about 0.1%, or at least about 0.5%) to at most about 0.05% (e.g., at most about 0.02%, at most about 0.01%, at most about 0.005%, at most about 0.002%, at most about 0.001%, at most about 0.0005%, at most about 0.0002%, at most about 0.0001%, at most about 0.00005%, or at most about 0.00002%) by weight of at least one nonionic surfactant.

In one or more embodiments, a POU cleaning composition can include from about 0.00001% to about 5% by weight of at least one first organic acid (e.g., a carboxylic acid or a polycarboxylic acid), from about 0.00001% to about 5% by weight of at least one second organic acid (e.g., an amino acid), from about 0.00001% to about 10% by weight of at least one anionic polymer, and from about 0.00001% to about 1% by weight of at least one nonionic surfactant. In one or more embodiments, a POU cleaning composition can include from about 0.00001% to about 25% by weight of at least one first organic acid, from about 0.00001% to about 25% by weight of at least one second organic acid, from about 0.00001% to about 25% by weight of at least one anionic polymer, and from about 0.00001% to about 1% by weight of at least one nonionic surfactant.

In one or more embodiments, a POU polisher rinse composition can include from about 0.00001% to about 25% by weight of at least one first organic acid, from about 0.00001% to about 25% by weight of at least one second organic acid, from about 0.00001% to about 25% by weight of at least one anionic polymer, and from about 0.00001% to about 1% by weight of at least one nonionic surfactant. In some embodiments, a POU polisher rinse composition can include at least about 0.00001% (e.g., at least about 0.00005%, at least about 0.0001%, at least about 0.0005%, at least about 0.001%, at least about 0.005%, at least about 0.01%, at least about 0.05%, at least about 0.1%, at least about 0.5%, or at least about 1%) to at most about 25% (e.g., at most about 20%, at most about 15%, at most about 10%, at most about 5%, at most about 1%, at most about 0.5%, or at most about 0.1%) by weight of at least one first organic acid; at least about 0.00001% (e.g., at least about 0.00005%, at least about 0.0001%, at least about 0.0005%, at least about 0.001%, at least about 0.005%, at least about 0.01%, at least about 0.05%, at least about 0.1%, at least about 0.5%, or at least about 1%) to at most about 25% (e.g., at most about 20%, at most about 15%, at most about 10%, at most about 5%, at most about 1%, at most about 0.5%, or at most about 0.1%) by weight of at least one second organic acid; at least about 0.00001% (e.g., at least about 0.00005%, at least about 0.0001%, at least about 0.0005%, at least about 0.001%, at least about 0.005%, at least about 0.01%, at least about 0.05%, at least about 0.1%, at least about 0.5%, or at least about 1%) to at most 25% (e.g., at most about 20%, at most about 15%, at most about 10%, at most about 5%, at most about 1%, at most about 0.5%, or at most about 0.1%) by weight of at least one anionic polymer; and at least about 0.00001% (e.g., at least about 0.00005%, at least about 0.0001%, at least about 0.0005%, at least about 0.001%, at least about 0.005%, at least about 0.01%, at least about 0.05%, at least about 0.1%, or at least about 0.5%) to at most about 1% (e.g., at most about 0.9%, at most about 0.8%, at most about 0.7%, at most about 0.6%, at most about 0.5%, at most about 0.4%, at most about 0.3%, at most about 0.2%, at most about 0.1%, at most about 0.05%, at most about 0.02%, or at most about 0.01%) by weight of at least one nonionic surfactant.

In one or more embodiments, a POU post-CMP composition can include from about 0.00001% to about 1% by weight of at least one first organic acid, from about 0.00001% to about 1% by weight of at least one second organic acid, from about 0.00001% to about 1% by weight of at least one anionic polymer, and from about 0.00001% to about 0.05% by weight of at least one nonionic surfactant. In some embodiments, a POU post-CMP composition can include at least about 0.00001% (e.g., at least about 0.00005%, at least about 0.0001%, at least about 0.0005%, at least about 0.001%, at least about 0.005%, at least about 0.01%, at least about 0.05%, at least about 0.1%, or at least about 0.5%) to at most about 1% (e.g., at most about 0.9%, at most about 0.8%, at most about 0.7%, at most about 0.6%, at most about 0.5%, at most about 0.4%, at most about 0.3%, at most about 0.2%, at most about 0.1%, at most about 0.05%, at most about 0.02%, or at most about 0.01%) by weight of at least one first organic acid; at least about 0.00001% (e.g., at least about 0.00005%, at least about 0.0001%, at least about 0.0005%, at least about 0.001%, at least about 0.005%, at least about 0.01%, at least about 0.05%, at least about 0.1%, or at least about 0.5%) to at most about 1% (e.g., at most about 0.9%, at most about 0.8%, at most about 0.7%, at most about 0.6%, at most about 0.5%, at most about 0.4%, at most about 0.3%, at most about 0.2%, at most about 0.1%, at most about 0.05%, at most about 0.02%, or at most about 0.01%) by weight of at least one second organic acid; at least about 0.00001% (e.g., at least about 0.00005%, at least about 0.0001%, at least about 0.0005%, at least about 0.001%, at least about 0.005%, at least about 0.01%, at least about 0.05%, at least about 0.1%, or at least about 0.5%) to at most 1% (e.g., at most about 0.9%, at most about 0.8%, at most about 0.7%, at most about 0.6%, at most about 0.5%, at most about 0.4%, at most about 0.3%, at most about 0.2%, at most about 0.1%, at most about 0.05%, at most about 0.02%, or at most about 0.01%) by weight of at least one anionic polymer; and at least about 0.00001% (e.g., at least about 0.00005%, at least about 0.0001%, at least about 0.0005%, at least about 0.001%, at least about 0.005%, at least about 0.01%, at least about 0.05%, at least about 0.1%, or at least about 0.5%) to at most about 0.05% (e.g., at most about 0.02%, at most about 0.01%, at most about 0.005%, at most about 0.002%, at most about 0.001%, at most about 0.0005%, at most about 0.0002%, at most about 0.0001%, at most about 0.00005%, or at most about 0.00002%) by weight of at least one nonionic surfactant.

In one or more embodiments, a POU cleaning composition can include from about 0.00001% to about 5% by weight of at least one chelating agent (e.g., a polycarboxylic acid), from about 0.00001% to about 5% by weight of at least one corrosion inhibitor (e.g., an amino acid), from about 0.00001% to about 10% by weight of at least one anionic polymer (e.g., any described herein), from about 0.00001% to about 1% by weight of at least one nonionic surfactant (e.g., a polysorbate), and from about 0.1 ppm to about 1000 ppm of at least one biocide (e.g., an isothiazolinone). In one or more embodiments, a POU cleaning composition can include from about 0.00001% to about 25% by weight of at least one chelating agent, from about 0.00001% to about 25% by weight of at least one corrosion inhibitor, from about 0.00001% to about 25% by weight of at least one anionic polymer, from about 0.00001% to about 1% by weight of at least one nonionic surfactant, and from about 0.1 ppm to about 1000 ppm of at least one biocide.

In one or more embodiments, a POU polisher rinse composition can include from about 0.00001% to about 25% by weight of at least one chelating agent, from about 0.00001% to about 25% by weight of at least one corrosion inhibitor, from about 0.00001% to about 25% by weight of at least one anionic polymer, from about 0.00001% to about 1% by weight of at least one nonionic surfactant, and from about 0.1 ppm to about 1000 ppm of at least one biocide. In some embodiments, a POU polisher rinse composition can include at least about 0.00001% (e.g., at least about 0.00005%, at least about 0.0001%, at least about 0.0005%, at least about 0.001%, at least about 0.005%, at least about 0.01%, at least about 0.05%, at least about 0.1%, at least about 0.5%, or at least about 1%) to at most about 25% (e.g., at most about 20%, at most about 15%, at most about 10%, at most about 5%, at most about 1%, at most about 0.5%, or at most about 0.1%) by weight of at least one chelating agent; at least about 0.00001% (e.g., at least about 0.00005%, at least about 0.0001%, at least about 0.0005%, at least about 0.001%, at least about 0.005%, at least about 0.01%, at least about 0.05%, at least about 0.1%, at least about 0.5%, or at least about 1%) to at most about 25% (e.g., at most about 20%, at most about 15%, at most about 10%, at most about 5%, at most about 1%, at most about 0.5%, or at most about 0.1%) by weight of at least one corrosion inhibitor; at least about 0.00001% (e.g., at least about 0.00005%, at least about 0.0001%, at least about 0.0005%, at least about 0.001%, at least about 0.005%, at least about 0.01%, at least about 0.05%, at least about 0.1%, at least about 0.5%, or at least about 1%) to at most 25% (e.g., at most about 20%, at most about 15%, at most about 10%, at most about 5%, at most about 1%, at most about 0.5%, or at most about 0.1%) by weight of at least one anionic polymer; at least about 0.00001% (e.g., at least about 0.00005%, at least about 0.0001%, at least about 0.0005%, at least about 0.001%, at least about 0.005%, at least about 0.01%, at least about 0.05%, at least about 0.1%, or at least about 0.5%) to at most about 1% (e.g., at most about 0.9%, at most about 0.8%, at most about 0.7%, at most about 0.6%, at most about 0.5%, at most about 0.4%, at most about 0.3%, at most about 0.2%, at most about 0.1%, at most about 0.05%, at most about 0.02%, or at most about 0.01%) by weight of at least one nonionic surfactant; and at least about 0.1 ppm (e.g., at least about 0.5 ppm, at least about 1 ppm, at least about 5 ppm, at least about 10 ppm, at least about 25 ppm, at least about 50 ppm, at least about 75 ppm, or at least about 100 ppm) to at most about 1000 ppm (e.g., at most about 500 ppm, at most about 250 ppm, at most about 100 ppm, at most about 50 ppm, at most about 20 ppm, at most about 10 ppm, at most 5 ppm, at most about 1 ppm, or at most about 0.5 ppm) of at least one biocide.

In one or more embodiments, a POU post-CMP composition can include from about 0.00001% to about 1% by weight of at least one chelating agent, from about 0.00001% to about 1% by weight of at least one corrosion inhibitor, from about 0.00001% to about 1% by weight of at least one anionic polymer, from about 0.00001% to about 0.05% by weight of at least one nonionic surfactant, and from about 0.1 ppm to about 100 ppm of at least one biocide. In some embodiments, a POU post-CMP composition can include at least about 0.00001% (e.g., at least about 0.00005%, at least about 0.0001%, at least about 0.0005%, at least about 0.001%, at least about 0.005%, at least about 0.01%, at least about 0.05%, at least about 0.1%, or at least about 0.5%) to at most about 1% (e.g., at most about 0.9%, at most about 0.8%, at most about 0.7%, at most about 0.6%, at most about 0.5%, at most about 0.4%, at most about 0.3%, at most about 0.2%, at most about 0.1%, at most about 0.05%, at most about 0.02%, or at most about 0.0¹%) by weight of at least one chelating agent; at least about 0.00001% (e.g., at least about 0.00005%, at least about 0.0001%, at least about 0.0005%, at least about 0.001%, at least about 0.005%, at least about 0.01%, at least about 0.05%, at least about 0.1%, or at least about 0.5%) to at most about 1% (e.g., at most about 0.9%, at most about 0.8%, at most about 0.7%, at most about 0.6%, at most about 0.5%, at most about 0.4%, at most about 0.3%, at most about 0.2%, at most about 0.1%, at most about 0.05%, at most about 0.02%, or at most about 0.01%) by weight of at least one corrosion inhibitor; at least about 0.00001% (e.g., at least about 0.00005%, at least about 0.0001%, at least about 0.0005%, at least about 0.001%, at least about 0.005%, at least about 0.01%, at least about 0.05%, at least about 0.1%, or at least about 0.5%) to at most 1% (e.g., at most about 0.9%, at most about 0.8%, at most about 0.7%, at most about 0.6%, at most about 0.5%, at most about 0.4%, at most about 0.3%, at most about 0.2%, at most about 0.1%, at most about 0.05%, at most about 0.02%, or at most about 0.01%) by weight of at least one anionic polymer; at least about 0.00001% (e.g., at least about 0.00005%, at least about 0.0001%, at least about 0.0005%, at least about 0.001%, at least about 0.005%, at least about 0.01%, at least about 0.05%, at least about 0.1%, or at least about 0.5%) to at most about 0.05% (e.g., at most about 0.02%, at most about 0.01%, at most about 0.005%, at most about 0.002%, at most about 0.001%, at most about 0.0005%, at most about 0.0002%, at most about 0.0001%, at most about 0.00005%, or at most about 0.00002%) by weight of at least one nonionic surfactant; and at least about 0.1 ppm (e.g., at least about 0.5 ppm, at least about 1 ppm, at least about 5 ppm, at least about 10 ppm, at least about 25 ppm, at least about 50 ppm, at least about 75 ppm, or at least about 100 ppm) to at most about 100 ppm (e.g., at most about 50 ppm, at most about 20 ppm, at most about 10 ppm, at most 5 ppm, at most about 1 ppm, or at most about 0.5 ppm) of at least one biocide.

In one or more embodiments, a concentrated composition can include from about 0.01% to about 30% by weight of at least one organic acid, from about 0.005% to about 15% by weight of at least one anionic polymer, and from about 0.005% to about 1% by weight of at least one nonionic surfactant.

In one or more embodiments, a concentrated composition can include from about 0.01% to about 30% by weight of at least one first organic acid (e.g., a carboxylic acid or a polycarboxylic acid), from about 0.01% to about 30% by weight of at least one second organic acid (e.g., an amino acid), from about 0.005% to about 15% by weight of at least one anionic polymer, and from about 0.005% to about 1% by weight of at least one nonionic surfactant.

In one or more embodiments, a concentrated composition can include from about 0.01% to about 30% by weight of at least one chelating agent (e.g., a polycarboxylic acid), from about 0.01% to about 30% by weight of at least one corrosion inhibitor (e.g., an amino acid), from about 0.005% to about 15% by weight of at least one anionic polymer (e.g., any described herein), from about 0.005% to about 1% by weight of at least one nonionic surfactant (e.g., a polysorbate), and from about 0.1 ppm to about 1000 ppm of at least one biocide (e.g., an isothiazolinone).

### Organic Acid

In one or more embodiments, the cleaning composition described herein can include at least one (e.g., two, three, or four) organic acid. As used herein, the term “acid” includes an acid or a salt thereof (e.g., a potassium or sodium salt thereof). In some embodiments, the at least one organic acid can be selected from the group consisting of carboxylic acids (e.g., monocarboxylic acids, polycarboxylic acids, and dienoic acids), amino acids, sulfonic acids, phosphoric acid, acrylic acids, and phosphonic acids, or salts thereof. In some embodiments, the at least one organic acid can be an acid or a salt thereof selected from the group consisting of formic acid, gluconic acid, acetic acid, malonic acid, citric acid, propionic acid, malic acid, adipic acid, succinic acid, aspartic acid, ascorbic acid, lactic acid, oxalic acid, hydroxyethylidene diphosphonic acid, 2-phosphono-1,2,4-butane tricarboxylic acid, aminotrimethylene phosphonic acid, hexamethylenediamine tetra(methylenephosphonic acid), bis(hexamethylene)triamine phosphonic acid, amino acetic acid, peracetic acid, potassium acetate, phenoxyacetic acid, benzoic acid, amino carboxylic acid, glycine, bicine, diglycolic acid, glyceric acid, tricine, alanine, histidine, valine, phenylalanine, proline, glutamine, aspartic acid, glutamic acid, arginine, lysine, tyrosine, 2,4-pentadienoic acid, 5-phenylpenta-2,4-dienoic acid, 2-hydroxypenta-2,4-dienoic acid, 2,4-hexadienoic acid (sorbic acid), 4,5-hexadienoic acid, 4,6-heptadienoic acid, 2,6-dimethylhepta-2,5-dienoic acid, (3E,5E)-hepta-3,5-dienoic acid, (2E,5Z)-hepta-2,5-dienoic acid, octa-3,5-dienoic acid, (Z)-3,7-dimethyl-2,6-octadienoic acid, 5,7-nonadienoic acid, (E,Z)-2,4-decadienoic acid, 2,5-decadienoic acid, undecadienoic acid, dodecadienoic acid, tridecadienoic acid, tetradecadienoic acid, pentadecadienoic acid, hexadecadienoic acid, heptadecadienoic acid, (9Z,12E)-octadeca-9,12-dienoic acid, octadeca-10,12-dienoic acid, (10E,15Z)-9,12,13-trihydroxyoctadeca-10,15-dienoic acid, 13(S)-hydroxyoctadeca-9Z,11E-dienoic acid, nonadecadienoic acid, henicosadienoic acid, docosadienoic acid, eicosa-11,14-dienoic acid, or mixtures thereof salts thereof, and mixtures thereof.

In some embodiments, the at least one organic acid includes at least one (e.g., two or three) carboxylic acid. The carboxylic acid can include monocarboxylic acids (e.g., a compound including a single carboxylic acid group, such as an aliphatic monocarboxylic acid or an aromatic monocarboxylic acid) or polycarboxylic acids (e.g., a compound having a plurality of carboxylic acid groups, such as an aliphatic dicarboxylic acid, an aliphatic tricarboxylic acid, an aromatic dicarboxylic acid, or an aromatic tricarboxylic acid, and the like). In some embodiments, the at least one carboxylic acid can be an acid or a salt thereof selected from the group consisting of citric acid, aconitic acid, isocitric acid, hydroxycitric acid, homocitric acid, homoisocitric acid, homoaconitic acid, oxalosuccinic acid, formic acid, gluconic acid, acetic acid, malonic acid, propionic acid, malic acid, adipic acid, succinic acid, aspartic acid, lactic acid, oxalic acid, 2-phosphono-1,2,4-butane tricarboxylic acid, phenoxyacetic acid, benzoic acid, amino carboxylic acid, glycine, bicine, diglycolic acid, glyceric acid, tricine, alanine, histidine, valine, phenylalanine, proline, glutamine, aspartic acid, glutamic acid, arginine, lysine, tyrosine, or others described herein.

In some embodiments, the at least one organic acid includes at least one (e.g., two or three) amino acid or polyamino acid. In one or more embodiments, the compositions described herein can optionally include a single amino acid or polyamino acid. In one or more embodiments, the amino acid is chemically distinct from the pH adjuster. In one or more embodiments, the amino acid is selected from the group consisting of alanine, histidine, valine, phenylalanine, proline, glutamine, aspartic acid, glutamic acid, arginine, lysine, tyrosine, and mixtures thereof. In one or more embodiments, the polyamino acid is selected from the group consisting of poly-DL-alanine, poly-L-arginine hydrochloride, poly-(α,β)-DL-aspartic acid sodium salt, poly-γ-benzyl-L-glutamate, poly-ε-Cbz-L-lysine, poly(γ-ethyl-L-glutamate), poly-D-glutamic acid sodium salt, poly-L-glutamic acid sodium salt, polyglycine, poly-L-histidine, poly(L-lactide), poly-D-lysine hydrobromide, poly-L-lysine hydrobromide, poly-DL-lysine hydrobromide, poly-L-ornithine hydrobromide, poly-DL-ornithine hydrobromide, poly-L-proline, poly-L-threonine, and mixtures thereof.

In one or more embodiments, the at least one organic acid includes a polycarboxylic acid (e.g., any described herein) and an amino acid (e.g., any described herein).

In one or more embodiments, the at least one organic acid is included in the composition in an amount from about 0.00001% to about 50% by weight of the cleaning composition. For example, the at least one organic acid can be at least about 0.00001% (e.g., at least about 0.00005%, at least about 0.0001%, at least about 0.0005%, at least about 0.001%, at least about 0.005%, at least about 0.01%, at least about 0.05%, at least about 0.1%, at least about 0.5% or at least about 1%) to at most about 50% (e.g., at most about 45%, at most about 40%, at most about 35%, at most about 30%, at most about 25%, at most about 20%, at most about 15%, at most about 10%, at most about 5%, at most about 3%, at most about 1%, at most about 0.5%, at most about 0.25%, at most about 0.1%, or at most about 0.05%) by weight of the cleaning composition described herein. The amounts described herein can include an amount for each organic acid present in the cleaning composition or an amount for the combination of organic acids present in the cleaning composition.

In one or more embodiments, the cleaning composition described herein can include at least one first organic acid. In some embodiments, the at least one first organic acid can be selected from the group consisting of carboxylic acids (e.g., monocarboxylic acids and polycarboxylic acids (such as bicarboxylic acids and tricarboxylic acids)), sulfonic acids, phosphoric acid, acrylic acids, peracids, and phosphonic acids. In some embodiments, the at least one first organic acid can be an acid selected from the group consisting of formic acid, gluconic acid, acetic acid, malonic acid, citric acid, propionic acid, malic acid, adipic acid, succinic acid, aspartic acid, ascorbic acid, lactic acid, oxalic acid, hydroxyethylidene diphosphonic acid, 2-phosphono-1,2,4-butane tricarboxylic acid, aminotrimethylene phosphonic acid, hexamethylenediamine tetra(methylenephosphonic acid), bis(hexamethylene)triamine phosphonic acid, amino acetic acid, peracetic acid, potassium acetate, phenoxyacetic acid, benzoic acid, amino carboxylic acid, glycine, bicine, tricine, alanine, histidine, valine, phenylalanine, proline, glutamine, aspartic acid, glutamic acid, arginine, lysine, tyrosine, and mixtures thereof. In some embodiments, the at least one first organic acid can be a tricarboxylic acid (e.g., citric acid). In some embodiments, the at least one first organic acid does not include an amino acid or a dienoic acid.

In one or more embodiments, the at least one first organic acid can be at least about 0.00001% (e.g., at least about 0.00005%, at least about 0.0001%, at least about 0.0005%, at least about 0.001%, at least about 0.005%, at least about 0.01%, at least about 0.05%, at least about 0.1%, at least about 0.5%, or at least about 1%) to at most about 50% (e.g., at most about 45%, at most about 40%, at most about 35%, at most about 30%, at most about 25%, at most about 20%, at most about 18%, at most about 16%, at most about 15%, at most about 14%, at most about 12%, at most about 10%, at most about 8%, at most about 6%, at most about 5%, at most about 4%, at most about 2%, at most about 1%, or at most about 0.5%) by weight of the cleaning composition described herein.

In one or more embodiments, the cleaning composition described herein can include at least one second organic acid different from the at least one first organic acid. In some embodiments, the at least one second organic acid can be an amino acid (e.g., a naturally occurring amino acid or a non-naturally occurring amino acid). In some embodiments, the at least one second organic acid can be selected from the group consisting of amino carboxylic acid (e.g., amino acetic acid), glycine, bicine, tricine, alanine, histidine, valine, phenylalanine, proline, glutamine, aspartic acid, glutamic acid, arginine, lysine, tyrosine, and mixtures thereof.

In one or more embodiments, the at least one second organic acid can be at least about 0.00001% (e.g., at least about 0.00005%, at least about 0.0001%, at least about 0.0005%, at least about 0.001%, at least about 0.005%, at least about 0.01%, at least about 0.05%, at least about 0.1%, at least about 0.5%, or at least about 1%) to at most about 50% (e.g., at most about 45%, at most about 40%, at most about 35%, at most about 30%, at most about 25%, at most about 20%, at most about 18%, at most about 16%, at most about 15%, at most about 14%, at most about 12%, at most about 10%, at most about 8%, at most about 6%, at most about 5%, at most about 4%, at most about 2%, at most about 1%, or at most about 0.5%) by weight of the cleaning composition described herein.

Without wishing to be bound by theory, it is believed that including the second organic acid (e.g., an amino acid) in the above amount range can improve corrosion inhibition of certain metal and metal containing films (e.g., W, Mo, Cu, TaN, or TiN) on the substrate during a buffing process and/or a post-CMP cleaning process. In some embodiments, cleaning compositions containing an amino acid can show better metal (e.g., W and/or Mo) corrosion protection than cleaning compositions without an amino acid.

In one or more embodiments, the cleaning composition described herein can include at least one third organic acid different from the at least one first and second organic acids. In some embodiments, the at least one third organic acid can be dienoic acid (i.e., an acid containing a diene). In some embodiments, the dienoic acid can have from 5 to 22 carbons (e.g., 5, 6, 7, 8, 9, 10, 11, 12, 13, 14, 15, 16, 17, 18, 19, 20, 21, or 22) carbons. In some embodiments, the dienoic acid can have from 5 to 12 (e.g., 5, 6, 7, 8, 9, 10, 11, or 12) carbons. In some embodiments, the dienoic acid can be a carboxylic acid containing a diene, such as 2,4-pentadienoic acid, 5-phenylpenta-2,4-dienoic acid, 2-hydroxypenta-2,4-dienoic acid, 2,4-hexadienoic acid (sorbic acid), 4,5-hexadienoic acid, 4,6-heptadienoic acid, 2,6-dimethylhepta-2,5-dienoic acid, (3E,5E)-hepta-3,5-dienoic acid, (2E,5Z)-hepta-2,5-dienoic acid, octa-3,5-dienoic acid, (Z)-3,7-dimethyl-2,6-octadienoic acid, 5,7-nonadienoic acid, (E,Z)-2,4-decadienoic acid, 2,5-decadienoic acid, undecadienoic acid, dodecadienoic acid, tridecadienoic acid, tetradecadienoic acid, pentadecadienoic acid, hexadecadienoic acid, heptadecadienoic acid, (9Z,12E)-octadeca-9,12-dienoic acid, octadeca-10,12-dienoic acid, (10E,15Z)-9,12,13-trihydroxyoctadeca-10,15-dienoic acid, 13(S)-hydroxyoctadeca-9Z,11E-dienoic acid, nonadecadienoic acid, henicosadienoic acid, docosadienoic acid, eicosa-11,14-dienoic acid, or mixtures thereof.

In one or more embodiments, the at least one third organic acid can be at least about 0.00001% (e.g., at least about 0.00005%, at least about 0.0001%, at least about 0.0005%, at least about 0.001%, at least about 0.005%, at least about 0.01%, at least about 0.02%, at least about 0.04%, or at least about 0.05%) to at most about 0.5% (e.g., at most about 0.4%, at most about 0.3%, at most about 0.2%, at most about 0.1%, at most about 0.08%, at most about 0.06%, at most about 0.05%, at most about 0.04%, at most about 0.03%, at most about 0.02%, at most about 0.01%, or at most about 0.005%) by weight of the cleaning composition described herein.

Without wishing to be bound by theory, it is believed that including the third organic acid (e.g., a dienoic acid) in the above amount range can improve corrosion inhibition of certain metal and metal containing films (e.g., W, Cu, TaN or TiN) on the substrate during a post-CMP cleaning process. In some embodiments, cleaning compositions containing a dienoic acid (e.g., sorbic acid) showed better metal (e.g., W) corrosion protection than cleaning compositions without a dienoic acid.

In one or more embodiments, the cleaning composition described herein includes two organic acids, such as (1) citric acid and histidine or (2) citric acid and glycine. In some embodiments, the cleaning composition includes three organic acids, such as (1) citric acid, histidine, and sorbic acid or (2) citric acid, histidine, and glycine. In some embodiments, the cleaning composition includes four organic acids (e.g., citric acid, histidine, sorbic acid and glycine).

In one or more embodiments, the cleaning composition can include at least two or three organic acids (e.g., a carboxylic acid, an amino acid, and/or a dienoic acid). In some embodiments, the first organic acid (e.g., a carboxylic acid) is in an amount of from about 0.0005% to about 10% by weight of the cleaning composition described herein. In other embodiments, the second organic acid (e.g., an amino acid) is in an amount of from about 0.005 to about 5% by weight of the cleaning composition described herein. In yet other embodiments, the third organic acid (e.g., a dienoic acid) is in an amount of from about 0.0005% to about 0.5% by weight of the cleaning composition described herein.

### Anionic Polymer

In one or more embodiments, the cleaning composition described herein can include at least one (e.g., two or three) anionic polymer. In one or more embodiments, the at least one anionic polymer can include one or more anionic groups, such as carboxylate, sulfate, and phosphate groups. In one or more embodiments, the at least one anionic polymer is formed from one or more monomers selected from the group consisting of (meth)acrylic acid, maleic acid, acrylic acid, acrylamide, malic acid, methacrylic acid, vinyl phosphonic acid, vinyl phosphoric acid, vinyl sulfonic acid, allyl sulfonic acid, styrene sulfonic acid, acrylamidopropyl sulfonic acid, phosphonic acid, phosphoric acid, butadiene/maleic acid, caprolactam, etherimide, 2-ethyl-2-oxazoline, N-iso-propylacrylamide, sodium phosphinite, and co-formed products thereof, and sodium, potassium, and ammonium salts thereof. In more specific embodiments, the at least one anionic polymer can be selected from the group consisting of poly(4-styrenylsulfonic) acid (PSSA), polyacrylic acid (PAA), poly(vinylphosphonic acid) (PVPA), poly(2-acrylamido-2-methyl-1-propanesulfonic acid), poly(N-vinylacetamide) (PNVA), polyethylenimine (PEI), anionic poly(methyl methacrylate) (PMMA), anionic polyacrylamide (PAM), polyaspartic acid (PASA), anionic poly(ethylene succinate) (PES), anionic polybutylene succinate (PBS), poly(vinyl alcohol) (PVA), 2-propenoic acid copolymer with 2-methyl-2-((1-oxo-2-propenyl)amino)-1-propanesulfonic acid monosodium salt and sodium phosphinite, 2-propenoic acid copolymer with 2-methyl-2-((1-oxo-2-propenyl)amino)-1-propanesulfonic acid monosodium salt and sodium hydrogen sulfite sodium salt, 2-acrylamido-2-methyl-1-propanesulfonic acid-acrylic acid copolymer, poly(4-styrenesulfonic acid-co-acrylic acid-co-vinylphosphonic acid) terpolymer, and mixtures thereof. Without wishing to be bound by theory, it is believed that the anionic polymer can solubilize hydrophobic polishing materials/defects on a wafer surface and facilitate their removing during a buffing process and/or a post-CMP cleaning process.

In one or more embodiments, the at least one anionic polymer can have a weight average molecular weight ranging from at least about 250 g/mol (e.g., at least about 500 g/mol, at least about 1000 g/mol, at least about 2,000 g/mol, at least about 5,000 g/mol, at least about 50,000 g/mol, at least about 100,000 g/mol, at least about 200,000 g/mol, or at least about 250,000 g/mol) to at most about 500,000 g/mol (e.g., at most about 400,000 g/mol, at most about 300,000 g/mol, at most about 200,000 g/mol, at most about 100,000 g/mol, or at most about 50,000 g/mol, or at most about 10,000 g/mol). In some embodiments, the at least one anionic polymer can have a weight average molecular weight ranging from at least about 1000 g/mol to at most about 10,000 g/mol. In some embodiments, the at least one anionic polymer can have a weight average molecular weight ranging from at least about 2000 g/mol to at most about 6,000 g/mol. In yet some embodiments, the at least one anionic polymer can have a weight average molecular weight of about 5,000 g/mol.

In some embodiments, the cleaning composition described herein includes one anionic polymer such as poly(vinylphosphonic acid), 2-acrylamido-2-methyl-1-propanesulfonic acid-acrylic acid copolymer, or poly(4-styrenesulfonic acid-co-acrylic acid-co-vinylphosphonic acid) terpolymer. In some embodiments, the cleaning composition described herein includes two anionic polymers, such as (1) poly(4-styrenylsulfonic) acid and poly(acrylic) acid or (2) 2-acrylamido-2-methyl-1-propanesulfonic acid-acrylic acid copolymer and poly(acrylic) acid.

In one or more embodiments, the at least one anionic polymer is included in the composition in an amount from about 0.00001% to about 50% by weight of the cleaning composition. For example, the at least one anionic polymer can be at least about 0.00001% (e.g., at least about 0.00005%, at least about 0.0001%, at least about 0.0005%, at least about 0.001%, at least about 0.005%, at least about 0.01%, at least about 0.05%, at least about 0.1%, at least about 0.5%, or at least about 1%) to at most about 50% (e.g., at most about 45%, at most about 40%, at most about 35%, at most about 30%, at most about 25%, at most about 20%, at most about 15%, at most about 10%, at most about 5%, or at most about 1%) by weight of the cleaning composition described herein.

In some embodiments, the cleaning composition can include at least two or three anionic polymers. In some embodiments, the first anionic polymer is in an amount of from about 0.0005% to about 50% by weight of the cleaning composition described herein. In some embodiments, the second anionic polymer is in an amount of from about 0.0005% to about 30% by weight of the cleaning composition described herein. In yet some other embodiments, the third anionic polymer is in an amount of from about 0.0005% to about 10% by weight of the cleaning composition described herein.

### Nonionic Surfactant

In one or more embodiments, the cleaning composition described herein can include at least one (e.g., two or three) nonionic surfactant. In one or more embodiments, the at least one nonionic surfactant is selected from the group consisting of polyoxyalkylene alkyl ether (e.g., polyoxyethylene stearyl ether), polyoxyalkylene alkenyl ether (e.g., polyoxyethylene oleyl ether), polyoxyethylene alkyl phenyl ether (e.g., polyoxyethylene nonyl phenyl ether), polyoxyalkylene glycol (e.g., polyoxypropylene polyoxyethylene glycol), polyoxyalkylene monoalkylate (monoalkyl fatty acid ester polyoxyalkylene) (e.g., polyoxyethylene monoalkylates such as polyoxyethylene monostearate and polyoxyethylene monooleate), polyoxyalkylene dialkylate (dialkyl fatty acid ester polyoxyalkylene) (e.g., polyoxyethylene dialkylates such as polyoxyethylene distearate and polyoxyethylene dioleate), bispolyoxyalkylene alkylamide (e.g., bispolyoxyethylene stearylamide), sorbitan fatty acid ester or polyoxyethylene sorbitan fatty acid ester (e.g., polysorbate), polyoxyethylene alkylamine, glycerine fatty acid ester, oxyethylene-oxypropylene block copolymer, acetylene glycol-based surfactant, acetylene-based polyoxyethylene oxide, and mixtures thereof.

In one or more embodiments, the nonionic surfactant is selected from the group consisting of alcohol alkoxylates (e.g., ethylene glycol), alkylphenol alkoxylates (e.g., 4-nonylphenyl-polyethylene glycol), tristyrylphenol alkoxylates (e.g., tristyrylphenol ethoxylate), sorbitan ester alkoxylates (e.g., polysorbates), polyalkoxylates (e.g., polyethylene glycol), polyalkylene oxide block copolymers (e.g., C₁₂-C₁₄ tert-alkylamines ethoxylated propoxylated), alkoxylated diamines, and mixtures thereof. In one or more embodiments, the nonionic surfactant is a polymer having a number average molecular weight of at least about 500 g/mol, or at least about 1,000 g/mol, or at least about 2,500 g/mol, or at least about 5,000 g/mol, or at least about 7,500 g/mol, or at least about 10,000 g/mol. In one or more embodiments, the nonionic surfactant is a polymer having a number average molecular weight of at most about 1,000,000 g/mol, or at most about 750,000 g/mol, or at most about 500,000 g/mol, or at most about 250,000 g/mol, or at most about 100,000 g/mol. Without wishing to be bound by theory, it is surprising that a nonionic surfactant (such as those described above) can be used in a cleaning composition described herein to enhance hydrophobic surface cleaning on a semiconductor substrate.

In some embodiments, the at least one nonionic surfactant includes at least one polysorbate. In some embodiments, the at least one polysorbate is a sorbitan ester alkoxylate which can optionally include one or more polyoxyethylene groups. In some embodiments, the at least one polysorbate is an ethoxylated sorbitan (a derivative of sorbitol) esterified with fatty acids (e.g., C₁₂-C₂₀ fatty acids), in which ethoxylation can include one or more polyoxyethylene groups or poly(ethylene glycol) (e.g., such as —(OCH₂CH₂)ₙ—, in which n is an integer of 1 to 100). Non-limiting examples of polysorbates include one or more of the following: Polysorbate 20 (polyoxyethylene (20) sorbitan monolaurate or Tween 20), Polysorbate 40 (polyoxyethylene (20) sorbitan monopalmitate or Tween 40), Polysorbate 60 (polyoxyethylene (20) sorbitan monostearate or Tween 60), Polysorbate 80 (polyoxyethylene (20) sorbitan monooleate or Tween 80), or a combination of any of these.

In one or more embodiments, the nonionic surfactant is included in the cleaning composition in an amount from about 0.00001% to about 10% by weight of the composition. For example, the nonionic surfactant can be at least about 0.00001% (e.g., at least about 0.00005%, at least about 0.0001%, at least about 0.0005%, at least about 0.001%, at least about 0.002%, at least about 0.004%, at least about 0.005%, at least about 0.006%, at least about 0.008%, at least about 0.01%, at least about 0.02%, at least about 0.04%, at least about 0.05%, at least about 0.06%, at least about 0.08%, at least about 0.1%, at least about 0.5%, or at least about 1%) by weight to at most about 10% (e.g., at most about 8%, at most about 6%, at most about 4%, at most about 2%, at most about 1%, at most about 0.8%, at most about 0.6%, or at most about 0.4%) by weight of the cleaning composition described herein.

### Chelating Agent

In one or more embodiments, the cleaning composition described herein can include at least one (e.g., two or three) chelating agent. In one or more embodiments, the at least one chelating agent can be any molecule containing multiple carboxylic or amino acids, or the combination of both functional groups. In some embodiments, the at least one chelating agent can be an acid or a salt thereof selected from the group consisting of ethylenediaminetetracetic acid (EDTA), iminodiacetic acid (IDA), N-hydroxyethyl-ethylenediaminetriacetic acid (NHEDTA), nitrilotriacetic acid (NTA), diethylenetriaminepentacetic acid (DTPA), hydroxyethylethylenediaminetriacetic acid (HEDTA), triethylenetetraaminehexaacetic acid (TTHA), propionic acid, citric acid, malonic acid, maleic acid, tartaric acid, glycolic acid, lactic acid, malic acid, oxalic acid, succinic acid, glycine, alanine, serine, or combinations thereof.

In some embodiments, the at least one chelating agent includes at least one (e.g., two or three) carboxylic acid. The carboxylic acid can include monocarboxylic acids (e.g., a compound including a single carboxylic acid group, such as an aliphatic monocarboxylic acid or an aromatic monocarboxylic acid) or polycarboxylic acids (e.g., a compound having a plurality of carboxylic acid groups, such as an aliphatic dicarboxylic acid, an aliphatic tricarboxylic acid, an aromatic dicarboxylic acid, or an aromatic tricarboxylic acid, and the like). In some embodiments, the at least one carboxylic acid can be an acid or a salt thereof selected from the group consisting of citric acid, aconitic acid, isocitric acid, hydroxycitric acid, homocitric acid, homoisocitric acid, homoaconitic acid, oxalosuccinic acid, formic acid, gluconic acid, acetic acid, malonic acid, propionic acid, malic acid, adipic acid, succinic acid, aspartic acid, lactic acid, oxalic acid, 2-phosphono-1,2,4-butane tricarboxylic acid, phenoxyacetic acid, benzoic acid, amino carboxylic acid, glycine, bicine, diglycolic acid, glyceric acid, tricine, alanine, histidine, valine, phenylalanine, proline, glutamine, aspartic acid, glutamic acid, arginine, lysine, tyrosine, or others described herein.

In one or more embodiments, the at least one chelating agent can be at least about 0.00001% (e.g., at least about 0.00005%, at least about 0.0001%, at least about 0.0005%, at least about 0.001%, at least about 0.005%, at least about 0.01%, at least about 0.05%, at least about 0.1%, at least about 0.5%, or at least about 1%) to at most about 50% (e.g., at most about 45%, at most about 40%, at most about 35%, at most about 30%, at most about 25%, at most about 20%, at most about 18%, at most about 16%, at most about 15%, at most about 14%, at most about 12%, at most about 10%, at most about 8%, at most about 6%, at most about 5%, at most about 4%, at most about 2%, at most about 1%, or at most about 0.5%) by weight of the cleaning composition described herein.

### Corrosion Inhibitor

In one or more embodiments, the cleaning composition described herein can include at least one (e.g., two or three) corrosion inhibitor. In one or more embodiments, the at least one corrosion inhibitor can be any molecule containing multiple carboxylic or amino acids, or the combination of both functional groups. In some embodiments, the at least one corrosion inhibitor can amino acid or polyamino acid. In one or more embodiments, the compositions described herein can optionally include a single amino acid or polyamino acid. In one or more embodiments, the amino acid is selected from the group consisting of alanine, histidine, valine, phenylalanine, proline, glutamine, aspartic acid, glutamic acid, arginine, lysine, tyrosine, and mixtures thereof. In one or more embodiments, the polyamino acid is selected from the group consisting of poly-DL-alanine, poly-L-arginine hydrochloride, poly-(α,β)-DL-aspartic acid sodium salt, poly-γ-benzyl-L-glutamate, poly-ε-Cbz-L-lysine, poly(γ-ethyl-L-glutamate), poly-D-glutamic acid sodium salt, poly-L-glutamic acid sodium salt, polyglycine, poly-L-histidine, poly(L-lactide), poly-D-lysine hydrobromide, poly-L-lysine hydrobromide, poly-DL-lysine hydrobromide, poly-L-ornithine hydrobromide, poly-DL-ornithine hydrobromide, poly-L-proline, poly-L-threonine, and mixtures thereof.

In one or more embodiments, the at least one corrosion inhibitor can be at least about 0.00001% (e.g., at least about 0.00005%, at least about 0.0001%, at least about 0.0005%, at least about 0.001%, at least about 0.005%, at least about 0.01%, at least about 0.05%, at least about 0.1%, at least about 0.5%, or at least about 1%) to at most about 50% (e.g., at most about 45%, at most about 40%, at most about 35%, at most about 30%, at most about 25%, at most about 20%, at most about 18%, at most about 16%, at most about 15%, at most about 14%, at most about 12%, at most about 10%, at most about 8%, at most about 6%, at most about 5%, at most about 4%, at most about 2%, at most about 1%, or at most about 0.5%) by weight of the cleaning composition described herein.

### Biocide

In one or more embodiments, the cleaning composition described herein can include at least one (e.g., two or three) biocide. Exemplary biocides include, but are not limited to, isothiazolinones (such as benzisothiazolinone, methylisothiazolinone, and methylchloroisothiazolinone), 2-bromo-2-nitropropane-1,3-diol, hydrogen peroxide, and combinations thereof. In some embodiments, the biocide can be in an amount of from at most about 1000 ppm (e.g., at most about 500 ppm, at most about 250 ppm, at most about 100 ppm, at most about 50 ppm, or at most about 10 ppm) to at least about 0.1 ppm (e.g., at least about 0.5 ppm, at least about 1 ppm, at least about 5 ppm, at least about 10 ppm, at least about 25 ppm, at least about 50 ppm, at least about 75 ppm, or at least about 100 ppm) of the cleaning composition described herein.

### Guanamine Compound

In one or more embodiments, the cleaning composition described herein can include at least one (e.g., two or three) guanamine compounds. In some embodiments, the guanamine compound includes a structure of formula (I):

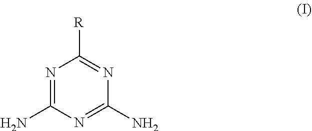

or a salt thereof,
wherein R can be any described herein.

In some embodiments, R can be a group that comprises an optionally substituted aliphatic (e.g., optionally substituted alkyl), optionally substituted aromatic (e.g., optionally substituted aryl), optionally substituted heterocyclic (e.g., optionally substituted heterocyclyl, such as optionally substituted triazinyl), or optionally substituted aromatic-aliphatic (e.g., optionally substituted arylalkyl).

In one or more embodiments, R is optionally substituted alkyl, optionally substituted aryl, optionally substituted aromatic, optionally substituted triazinyl, or optionally substituted arylalkyl. In one or more embodiments, the cleaning composition described herein can include a single guanamine compound according to formula (I). In one or more embodiments, R in formula (I) is a substituted or unsubstituted C₁-C₂₀ alkyl group, a substituted or unsubstituted C₂-C₂₀ alkenyl group, a substituted or unsubstituted cycloalkyl group, or a substituted or unsubstituted aryl group.

In some embodiments, the guanamine compound includes a structure of formula (IA):

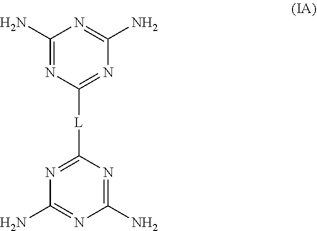

or a salt thereof,
wherein L can be any described herein.

In some embodiments, L is a linker (e.g., optionally substituted aliphatic, optionally substituted heteroaliphatic, or a combination thereof, as well as any described herein). In some embodiments, L is

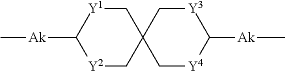

or -Ak-; each Ak is, independently, a covalent bond, optionally substituted aliphatic (e.g., optionally substituted alkylene), or optionally substituted heteroaliphatic (e.g., optionally substituted heteroalkylene); and each of Y¹, Y², Y³, and Y⁴ is, independently, alkylene (e.g., —CR^{C1}R^{C2}—, in which each of R^{C1} and R^{C2} is, independently, hydrogen, aliphatic, heteroaliphatic, aromatic, as defined herein, or any combination thereof), oxy (—O—), thio (—S—), or imino (—NR^{N1}—, in which R^{N1} is hydrogen, aliphatic, heteroaliphatic, aromatic, as defined herein, or any combination thereof).

In one or more embodiments, the at least one guanamine may be a bisguanamine.

In one or more embodiments, the at least one guanamine is selected from the group consisting of butyroguanamine, acetoguanamine, benzoguanamine, caprinoguanamine, adipoguanamine, stearoguanamine, 2,4-diamine-6-nonyl-1,3,5-triazine, 2,4-diamino-6-undecyl-1,3,5-triazine, 3,9-bis[2-(3,5-diamino-2,4,6-triazaphenyl)ethyl]-2,4,8,10-tetraoxaspiro[5.5]undecane, 2,4-diamino-6-butylamino-1,3,5-triazine, 2,4-diamino-6-(4-methylphenyl)-1,3,5-triazine, 2,4-diamino-6-[2-(2-methyl-1-imidazolyl)ethyl]-1,3,5-triazine, 2,4-diamino-6-[2-(2-undecyl-1-imidazolyl)ethyl]-1,3,5-triazine, and mixtures thereof.

Without wishing to be bound by theory, the inventors surprisingly discovered that the guanamine compound can be highly effective at reducing corrosion of certain materials (e.g., W/Mo) in a semiconductor substrate when the substrate is contacted by the cleaning composition described herein.

In some embodiments, the cleaning composition can include about 0.1 ppm to about 1000 ppm of a guanamine compound (e.g., any described herein). In some embodiments, a point-of-use (POU) composition (e.g., a POU cleaning composition, a POU polisher rinse composition, and/or a POU post-CMP composition) includes from about 0.1 ppm to about 500 ppm by weight of a guanamine compound (e.g., any described herein). In some embodiments, a concentrated composition includes from about 1 ppm to about 1000 ppm of a guanamine compound (e.g., any described herein).

In one or more embodiments, the guanamine compound is included in a cleaning composition described herein in an amount from at least about 0.1 ppm (e.g., at least about 0.5 ppm, at least about 1 ppm, at least about 5 ppm, at least about 10 ppm, at least about 25 ppm, at least about 50 ppm, at least about 75 ppm, or at least about 100 ppm) to at most about 1000 ppm (e.g., at most about 900 ppm, at most about 800 ppm, at most about 700 ppm, at most about 600 ppm, at most about 500 ppm, or at most about 250 ppm) based on the total weight of the composition.

### Oxidizer

In one or more embodiments, the cleaning composition described herein can optionally include at least one (e.g., two or three) oxidizer. In one or more embodiments, the cleaning composition optionally includes a single oxidizer. In some embodiments, an oxidizer can be added when diluting a concentrated composition to form a POU composition (e.g., a POU polisher rinse composition and/or a POU post-CMP composition).

The oxidizer can be selected from the group consisting of hydrogen peroxide, ammonium persulfate, silver nitrate (AgNO₃), ferric nitrates or chlorides, per acids or salts, ozone water, potassium ferricyanide, potassium dichromate, potassium iodate, potassium bromate, potassium periodate, periodic acid, vanadium trioxide, hypochlorous acid, sodium hypochlorite, potassium hypochlorite, calcium hypochlorite, magnesium hypochlorite, potassium permanganate, other inorganic or organic peroxides, and mixtures thereof. In one embodiment, the oxidizer is hydrogen peroxide.

In some embodiments, the oxidizer is in an amount of from at least about 0.05% (e.g., at least about 0.1%, at least about 0.2%, at least about 0.4%, at least about 0.5%, at least about 1%, at least about 1.5%, at least about 2%, at least about 2.5%, at least about 3%, at least about 3.5%, at least about 4%, or at least about 4.5%) by weight to at most about 5% (e.g., at most about 4.5%, at most about 4%, at most about 3.5%, at most about 3%, at most about 2.5%, at most about 2%, at most about 1.5%, at most about 1%, at most about 0.5%, or at most about 0.1%) by weight of the cleaning composition described herein. In some embodiments, without wishing to be bound by theory, it is believed that the oxidizer can help remove metal films by forming a metal complex with the chelating agent so that the metal can be removed during the CMP process. In some embodiments, without wishing to be bound by theory, it is believed that the oxidizer can help passivate a metal surface by forming an oxide film that can increase the corrosion resistance of the metal film. In some embodiments, the oxidizer may reduce the shelf life of a polisher rinse composition and/or the post-CMP composition. In such embodiments, the oxidizer can be added to the polisher rinse composition at the point of use right before a rinse polishing/buffing process or added to the post-CMP composition at the point of use right before a post-CMP process.

### pH Value

The cleaning compositions (e.g., a concentrated composition, a polisher rinse composition, and/or a post-CMP composition) described herein can have any useful pH. Desired pH (or pH ranges) can be obtained by using at least one pH adjuster (e.g., an acid, a base, or a mixture thereof, including any described herein).

In some embodiments, the pH value of the cleaning composition (e.g., a concentrated composition, a polisher rinse composition, and/or a post-CMP composition) described herein can range from at least about 1 (e.g., at least about 1.5, at least about 2, at least about 2.5, at least about 3, at least about 3.5, at least about 4, at least about 4.5, at least about 5, at least about 5.5, at least about 6, or at least about 6.5) to at most about 7 (e.g., at most about 6.5, at most about 6, at most about 5.5, at most about 5, at most about 4.5, at most about 4, at most about 3.5, at most about 3, at most about 2.5, or at most about 2). Without wishing to be bound by theory, it is believed that, when the cleaning composition described herein has an acidic pH within the above range, it can provide enough protons to solubilize the organic residues generated from CMP polishing of the substrates and can provide enough cleaning action to solubilize the inert metal (e.g., W, Cu) containing polishing byproducts.

In some embodiments, the pH value of the polisher rinse composition described herein can range from at least about 1 (e.g., at least about 1.5, at least about 2, at least about 2.5, at least about 3, at least about 3.5, at least about 4, at least about 4.5, at least about 5, at least about 5.5, at least about 6, or at least about 6.5) to at most about 7 (e.g., at most about 6.5, at most about 6, at most about 5.5, at most about 5, at most about 4.5, at most about 4, at most about 3.5, at most about 3, at most about 2.5, or at most about 2).

In some embodiments, the pH value of the post-CMP composition described herein can range from at least about 1 (e.g., at least about 1.5, at least about 2, at least about 2.5, at least about 3, at least about 3.5, at least about 4, at least about 4.5, at least about 5, at least about 5.5, at least about 6, or at least about 6.5) to at most about 7 (e.g., at most about 6.5, at most about 6, at most about 5.5, at most about 5, at most about 4.5, at most about 4, at most about 3.5, at most about 3, at most about 2.5, or at most about 2).

Without wishing to be bound by theory, it is believed that the pH of the CMP composition should be considered when determining an optimal pH for a cleaning composition, in which similar pH for such cleaning compositions may result in more effective removal of the debris/residue left behind on the polished substrate during buffing and/or post-CMP processes. In some embodiments, the pH value of the polisher rinse composition and/or the post-CMP composition can be acidic if the pH value of the CMP composition used to polish the substrate was acidic; or the pH value of the polisher rinse composition and/or the post-CMP composition can be basic if the pH value of the CMP composition used to polish the substrate was basic. To obtain the desired pH, the relative concentrations of the ingredients in the cleaning compositions described herein can be adjusted.

In other embodiments, the pH of the cleaning composition may affect corrosion of the metal (e.g., tungsten and/or molybdenum) surfaces (e.g., an acidic pH may reduce corrosion), may affect the static etch rate of metal (e.g., tungsten and/or molybdenum) surfaces (e.g., an acidic pH may have a reduced static etch rate), and/or may affect selectivity of removing a metal over its corresponding metal oxide; and such considerations may be used to determine a desired pH for any cleaning composition herein. To obtain the desired pH, the relative concentrations of the ingredients in the cleaning compositions described herein can be adjusted.

In some embodiments, the pH value of the cleaning composition (e.g., a concentrated composition, a polisher rinse composition, and/or a post-CMP composition) described herein can range from at least about 7 (e.g., at least about 7.5, at least about 8, at least about 8.5, at least about 9, at least about 9.5, at least about 10, at least about 10.5, at least about 11, or at least about 11.5) to at most about 14 (e.g., at most about 13.5, at most about 13, at most about 12.5, at most about 12, at most about 11.5, at most about 11, at most about 10.5, at most about 10, or at most about 9.5).

In some embodiments, the pH value of the polisher rinse composition described herein can range from at least about 7 (e.g., at least about 7.5, at least about 8, at least about 8.5, at least about 9, at least about 9.5, at least about 10, at least about 10.5, at least about 11, or at least about 11.5) to at most about 14 (e.g., at most about 13.5, at most about 13, at most about 12.5, at most about 12, at most about 11.5, at most about 11, at most about 10.5, at most about 10, or at most about 9.5).

In some embodiments, the pH value of the post-CMP composition described herein can range from at least about 7 (e.g., at least about 7.5, at least about 8, at least about 8.5, at least about 9, at least about 9.5, at least about 10, at least about 10.5, at least about 11, or at least about 11.5) to at most about 14 (e.g., at most about 13.5, at most about 13, at most about 12.5, at most about 12, at most about 11.5, at most about 11, at most about 10.5, at most about 10, or at most about 9.5).

The pH of the cleaning composition (e.g., a concentrated composition, a polisher rinse composition, and/or a post-CMP composition) described herein can be optimized to provide one or more desired characteristics (e.g., any described herein, such as optimal selectivity for removing a metal oxide, as compared to the corresponding metal; optimal static etch rate (SER) for the metal; and/or optimal cleaning performance of at least one defect, such as residue, particles, scratches, etc.).

In some embodiments, the pH value of the cleaning composition (e.g., a concentrated composition, a polisher rinse composition, and/or a post-CMP composition) described herein can range from at least about 4 (e.g., at least about 4.5, at least about 5, at least about 5.5, at least about 6, at least about 6.5, at least about 7, at least about 7.5, at least about 8, or at least about 8.5) to at most about 9.5 (e.g., at most about 9, at most about 8.5, at most about 8, at most about 7.5, at most about 7, at most about 6.5, at most about 6, at most about 5.5, at most about 5, or at most about 4.5).

In some embodiments, the pH value of the polisher rinse composition described herein can range from at least about 4 (e.g., at least about 4.5, at least about 5, at least about 5.5, at least about 6, at least about 6.5, at least about 7, at least about 7.5, at least about 8, or at least about 8.5) to at most about 9.5 (e.g., at most about 9, at most about 8.5, at most about 8, at most about 7.5, at most about 7, at most about 6.5, at most about 6, at most about 5.5, at most about 5, or at most about 4.5).

In some embodiments, the pH value of the post-CMP composition described herein can range from at least about 4 (e.g., at least about 4.5, at least about 5, at least about 5.5, at least about 6, at least about 6.5, at least about 7, at least about 7.5, at least about 8, or at least about 8.5) to at most about 9.5 (e.g., at most about 9, at most about 8.5, at most about 8, at most about 7.5, at most about 7, at most about 6.5, at most about 6, at most about 5.5, at most about 5, or at most about 4.5).

The pH value of the concentrated composition can be the same or different from the polisher rinse composition and/or the post-CMP composition, even when the polisher rinse composition and the post-CMP composition are formed by diluting the concentrated composition. Depending on the types and concentration of certain components within the concentrated composition, the extent of dilution can maintain the pH value to be that of the initial composition (e.g., for a composition having high buffering capacity) or the pH value may change. For example, and without limitation, an acidic concentrated composition (e.g., having a pH less than about 7, such as a pH from 1 to 6.5) can have a lower pH value than those compositions obtained after dilution. In another non-limiting example, an alkaline concentrated composition (e.g., having a pH greater than about 7, such as a pH from 7.5 to 14) can have a higher pH value than those compositions obtained after dilution.

In some embodiments, the polisher rinse composition has a difference in pH value that is no more than about ±3 (e.g., no more than about ±2.5, no more than about ±2, no more than about ±1.5, no more than about ±1, or no more than about ±0.5), as compared to the pH value of the concentrated composition. In some embodiments, the pH value of the polisher rinse composition can be substantially the same as the pH value of the concentrated composition.

In some embodiments, the post-CMP composition has a difference in pH value that is no more than about ±3 (e.g., no more than about ±2.5, no more than about ±2, no more than about ±1.5, no more than about ±1, or no more than about ±0.5), as compared to the pH value of the concentrated composition. In some embodiments, the pH value of post-CMP composition can be substantially the same as the pH value of the concentrated composition.

In some embodiments, the post-CMP composition has a difference in pH value that is no more than about ±3 (e.g., no more than about ±2.5, no more than about ±2, no more than about ±1.5, no more than about ±1, or no more than about ±0.5), as compared to the pH value of the polisher rinse composition. In some embodiments, the pH value of post-CMP composition can be substantially the same as the pH value of the polisher rinse composition.

### pH Adjuster

In one or more embodiments, the cleaning composition described herein can include at least one (e.g., two or three) pH adjuster that is selected from the group consisting of an acid, a base, or a mixture thereof. In one or more embodiments, the cleaning composition described herein can include a single pH adjuster.

In one or more embodiments, the at least one pH adjuster is a base selected from inorganic bases, organic bases, and mixtures thereof. In some embodiments, the inorganic base can be selected from the group consisting of ammonium hydroxide, sodium hydroxide, lithium hydroxide, potassium hydroxide, cesium hydroxide, rubidium hydroxide, and any combinations thereof.

In one or more embodiments, the organic base is an alkanolamine (e.g., including one or more hydroxyl groups and one or more amino groups on an alkane backbone), a quaternary ammonium hydroxide (e.g., an alkylammonium hydroxide such as a tetraalkylammonium hydroxide), a quaternary phosphonium hydroxide (e.g., an alkylphosphonium hydroxide such as a tetraalkylphosphonium hydroxide), or a mixture of any of these. In one or more embodiments, the alkanolamine is selected from the group consisting of tris(hydroxymethyl)aminomethane (Tris), monoethanolamine (MEA, or 2-aminoethanol), 2-amino-2-methyl-1-propanol (AMP), diethanolamine (DEA), triethanolamine (TEA), diethylene glycol amine (DEGA), dimethylbis(2-hydroxyethyl)ammonium hydroxide (AH212), 2-(2-hydroxyethyl)ethanol (AEE), 2-(methylamino)-2-methyl-1-propanol (N-MAMP), and 2-(2-aminoethylamino)ethanol (AAE).

In one or more embodiments, the quaternary ammonium hydroxide is selected from the group consisting of tetrabutylammonium hydroxide, ethyltrimethylammonium hydroxide, tetrapropylammonium hydroxide, tetraethylammonium hydroxide, tetramethylammonium hydroxide, diethyldimethylammonium hydroxide, dimethyldipropylammonium hydroxide, tris (2-hydroxyethyl) methylammonium hydroxide, benzyltrimethylammonium hydroxide, and any combinations thereof. In one or more embodiments, the quaternary phosphonium hydroxide is selected from the group consisting of tetramethylphosphonium hydroxide, tetraethylphosphonium hydroxide, tetrapropylphosphonium hydroxide, tetrabutylphosphonium hydroxide, tetrapentylphosphonium hydroxide, triethylmethylphosphonium hydroxide, tetrakis(hydroxymethyl)phosphonium hydroxide, tetraphenylphosphonium hydroxide, and any combinations thereof. In one or more embodiments, the quaternary ammonium hydroxide or quaternary phosphonium hydroxide does not include covalently bound hydroxyl groups (e.g., does not include choline hydroxide or tris(2-hydroxyethyl)methylammonium hydroxide).

In one or more embodiments, the at least one pH adjuster is an acid selected from inorganic acids, organic acids, and mixtures thereof. In some embodiments, the inorganic acid can be selected from the group consisting of nitric acid, sulfuric acid, sulfurous acid, phosphoric acid, phosphonic acid, hydrochloric acid, periodic acid or any combinations thereof.

In one or more embodiments, the pH adjuster is an acid selected from the group consisting of gluconic acid, lactic acid, citric acid, tartaric acid, malic acid, glycolic acid, malonic acid, formic acid, oxalic acid, acetic acid, propionic acid, peracetic acid, adipic acid, succinic acid, amino acetic acid, phenoxyacetic acid, bicine, diglycolic acid, glyceric acid, tricine, alanine, histidine, valine, isoleucine, leucine, methionine, phenylalanine, cysteine, selenocysteine, glycine, proline, serine, threonine, asparagine, glutamine, aspartic acid, glutamic acid, arginine, histidine, lysine, tyrosine, tryptophan, benzoic acid, 1,2-ethanedisulfonic acid, 4-amino-3-hydroxy-1-naphthalenesulfonic acid, 8-hydroxyquinoline-5-sulfonic acid, aminomethanesulfonic acid, benzenesulfonic acid, hydroxylamine O-sulfonic acid, methanesulfonic acid, m-xylene-4-sulfonic acid, poly(4-styrenesulfonic acid), polyanetholesulfonic acid, p-toluenesulfonic acid, trifluoromethane-sulfonic acid, ethyl phosphoric acid, cyanoethyl phosphoric acid, phenyl phosphoric acid, vinyl phosphoric acid, poly(vinylphosphonic acid), 1-hydroxyethane-1,1-diphosphonic acid, nitrilotri(methylphosphonic acid), diethylenetriaminepentakis (methylphosphonic acid), N,N,N′,N′-ethylenediaminetetrakis(methylene phosphonic acid), n-hexylphosphonic acid, benzylphosphonic acid, phenylphosphonic acid, salts thereof, and mixtures thereof.

In the cleaning composition of the present disclosure, the pH adjuster can be present in an amount sufficient to adjust the pH to the desired value and thus will depend on the concentration of the components (e.g., organic acid, amino acid, etc.) and their acid strength as well as the presence of optional components affecting the pH of the cleaning composition.

In one or more embodiments, the at least one pH adjuster is in an amount from about 0.00001% to 15% by weight of the cleaning composition. For example, the at least one pH adjuster can be at least about 0.00001% (e.g., at least about 0.00005%, at least about 0.0001%, at least about 0.0005%, at least about 0.001%, at least about 0.005%, at least about 0.01%, at least about 0.05%, at least about 0.1%, at least about 0.5%, at least about 1%, at least about 2.5%, or at least about 3%) by weight to at most about 15% (e.g., at most about 12%, at most about 10%, at most about 7.5%, at most about 5%, at most about 2.5%, or at most about 1%) by weight of the cleaning composition described herein.

Without wishing to be bound by theory, the inventors surprisingly discovered that the use of pH adjusters to keep the pH of the cleaning composition acidic can reduce corrosion of the tungsten surfaces and/or molybdenum surfaces that may be present during buffing and/or post-CMP cleaning.

### Solvent

In some embodiments, the cleaning composition described herein can include a solvent (e.g., a primary solvent), such as water. In some embodiments, the solvent (e.g., water) is in an amount of from at least about 20% (e.g., at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 92%, at least about 94%, at least about 95%, or at least about 97%) by weight to at most about 99% (e.g., at most about 98%, at most about 96%, at most about 94%, at most about 92%, at most about 90%, at most about 85%, at most about 80%, at most about 75%, at most about 70%, or at most about 65%) by weight of the cleaning composition described herein.

In one or more embodiments, an optional secondary solvent (e.g., an organic solvent) can be used in the cleaning composition (e.g., a POU polisher rinse composition, a POU post-CMP composition, and/or a concentrated composition) of the present disclosure, which can help with the dissolution of one or more components in the cleaning composition (e.g., a guanamine compound, a corrosion inhibitor, or other component described herein). In one or more embodiments, the secondary solvent can be one or more alcohols, alkylene glycols, or alkylene glycol ethers. In one or more embodiments, the secondary solvent includes one or more solvents selected from the group consisting of ethanol, 1-propanol, 2-propanol, n-butanol, propylene glycol, 2-methoxyethanol, 2-ethoxyethanol, propylene glycol propyl ether, and ethylene glycol.

In some embodiments, the secondary solvent is in an amount of from at least about 0.0025% (e.g., at least about 0.005%, at least about 0.01%, at least about 0.02%, at least about 0.05%, at least about 0.1%, at least about 0.2%, at least about 0.4%, at least about 0.6%, at least about 0.8%, or at least about 1%) by weight to at most about 2% (e.g., at most about 1.8%, at most about 1.6%, at most about 1.5%, at most about 1.4%, at most about 1.2%, at most about 1%, at most about 0.8%, at most about 0.6%, at most about 0.5%, or at most about 0.1%) by weight of the cleaning composition described herein.

### Definitions

Unless otherwise specified, one or more of the following can be employed for any compound or component described herein.

By “aliphatic” is meant a hydrocarbon group having at least one carbon atom to 50 carbon atoms (C₁₋₅₀). For example, the hydrocarbon group can have at least one carbon atom (C₁) (e.g., at least 2 carbon atoms (C₂), at least 3 carbon atoms (C₃), at least 4 carbon atoms (C₄), at least 5 carbon atoms (C₅), at least 6 carbon atoms (C₆), at least 7 carbon atoms (C₇), at least 8 carbon atoms (C₈), at least 10 carbon atoms (C₁₀), at least 12 carbon atoms (C₁₂), at least 14 carbon atoms (C₁₄), at least 16 carbon atoms (C₁₆), at least 18 carbon atoms (C₁₈), or at least 20 carbon atoms (C₂₀)) and/or at most 50 carbon atoms (C₅₀) (e.g., at most 49 carbon atoms (C₄₉), at most 48 carbon atoms (C₄₈), at most 47 carbon atoms (C₄₇), at most 46 carbon atoms (C₄₆), at most 45 carbon atoms (C₄₅), at most 44 carbon atoms (C₄₄), at most 43 carbon atoms (C₄₃), at most 42 carbon atoms (C₄₂), at most 41 carbon atoms (C₄₁), at most 40 carbon atoms (C₄₀), at most 38 carbon atoms (C₃₈), at most 36 carbon atoms (C₃₆), at most 34 carbon atoms (C₃₄), at most 32 carbon atoms (C₃₂), at most 30 carbon atoms (C₃₀), at most 28 carbon atoms (C₂₈), at most 26 carbon atoms (C₂₆), at most 24 carbon atoms (C₂₄), at most 22 carbon atoms (C₂₂), at most 20 carbon atoms (C₂₀), at most 18 carbon atoms (C₁₈), at most 16 carbon atoms (C₁₆), at most 14 carbon atoms (C₁₄), at most 12 carbon atoms (C₁₂), at most 10 carbon atoms (C₁₀), at most 9 carbon atoms (C₉), at most 8 carbon atoms (C₈), at most 7 carbon atoms (C₇), at most 6 carbon atoms (C₆), at most 5 carbon atoms (C₅), at most 4 carbon atoms (C₄), or at most 3 carbon atoms (C₃). The aliphatic group can include alkanes (or alkyl), alkenes (or alkenyl), alkynes (or alkynyl), including cyclic versions thereof, and further including straight- and branched-chain arrangements, and all stereo and position isomers as well. The aliphatic group can also be unsubstituted or substituted (e.g., with one or more substituents described herein for alkyl). The aliphatic group can be monovalent or multivalent (e.g., bivalent) by removing one or more hydrogens to form appropriate attachment to the parent molecular group, which can include monovalent or multivalent forms of alkanes (or alkyl or alkylene), alkenes (or alkenyl or alkenylene), alkynes (or alkynyl or alkynylene).

By “alkenyl” is meant an unsaturated monovalent hydrocarbon group having at least two carbon atom to 50 carbon atoms (C₂₋₅₀) and at least one carbon-carbon double bond, in which the unsaturated monovalent hydrocarbon group can be derived from removing one hydrogen atom from one carbon atom of a parent alkene. For example, the unsaturated monovalent hydrocarbon group can have at least 2 carbon atoms (C₂) (e.g., at least 3 carbon atoms (C₃), at least 4 carbon atoms (C₄), at least 5 carbon atoms (C₅), at least 6 carbon atoms (C₆), at least 7 carbon atoms (C₇), at least 8 carbon atoms (C₈), at least 10 carbon atoms (C₁₀), at least 12 carbon atoms (C₁₂), at least 14 carbon atoms (C₁₄), at least 16 carbon atoms (C₁₆), at least 18 carbon atoms (C₁₈), or at least 20 carbon atoms (C₂₀)) and/or at most 50 carbon atoms (C₅₀) (e.g., at most 49 carbon atoms (C₄₉), at most 48 carbon atoms (C₄₈), at most 47 carbon atoms (C₄₇), at most 46 carbon atoms (C₄₆), at most 45 carbon atoms (C₄₅), at most 44 carbon atoms (C₄₄), at most 43 carbon atoms (C₄₃), at most 42 carbon atoms (C₄₂), at most 41 carbon atoms (C₄₁), at most 40 carbon atoms (C₄₀), at most 38 carbon atoms (C₃₈), at most 36 carbon atoms (C₃₆), at most 34 carbon atoms (C₃₄), at most 32 carbon atoms (C₃₂), at most 30 carbon atoms (C₃₀), at most 28 carbon atoms (C₂₈), at most 26 carbon atoms (C₂₆), at most 24 carbon atoms (C₂₄), at most 22 carbon atoms (C₂₂), at most 20 carbon atoms (C₂₀), at most 18 carbon atoms (C₁₈), at most 16 carbon atoms (C₁₆), at most 14 carbon atoms (C₁₄), at most 12 carbon atoms (C₁₂), at most 10 carbon atoms (C₁₀), at most 9 carbon atoms (C₉), at most 8 carbon atoms (C₈), at most 7 carbon atoms (C₇), at most 6 carbon atoms (C₆), at most 5 carbon atoms (C₅), at most 4 carbon atoms (C₄), or at most 3 carbon atoms (C₃). An alkenyl group can be branched, straight-chain, cyclic (e.g., cycloalkenyl), cis, or trans (e.g., E or Z). An example of an alkenyl includes an optionally substituted C₂₋₂₄ alkyl group having one or more double bonds. The alkenyl group can be monovalent or multivalent (e.g., bivalent) by removing one or more hydrogens to form appropriate attachment to the parent molecular group. The alkenyl group can also be unsubstituted or substituted (e.g., with one or more substituents described herein for alkyl).

By “alkyl” is meant a saturated monovalent hydrocarbon group having at least one carbon atom to 50 carbon atoms (C₁₋₅₀), in which the saturated monovalent hydrocarbon group can be derived from removing one hydrogen atom from one carbon atom of a parent compound (e.g., alkane). For example, the saturated monovalent hydrocarbon group can have at least one carbon atom (C₁) (e.g., at least 2 carbon atoms (C₂), at least 3 carbon atoms (C₃), at least 4 carbon atoms (C₄), at least 5 carbon atoms (C₅), at least 6 carbon atoms (C₆), at least 7 carbon atoms (C₇), at least 8 carbon atoms (C₈), at least 10 carbon atoms (C₁₀), at least 12 carbon atoms (C₁₂), at least 14 carbon atoms (C₁₄), at least 16 carbon atoms (C₁₆), at least 18 carbon atoms (C₁₈), or at least 20 carbon atoms (C₂₀)) and/or at most 50 carbon atoms (C₅₀) (e.g., at most 49 carbon atoms (C₄₉), at most 48 carbon atoms (C₄₈), at most 47 carbon atoms (C₄₇), at most 46 carbon atoms (C₄₆), at most 45 carbon atoms (C₄₅), at most 44 carbon atoms (C₄₄), at most 43 carbon atoms (C₄₃), at most 42 carbon atoms (C₄₂), at most 41 carbon atoms (C₄₁), at most 40 carbon atoms (C₄₀), at most 38 carbon atoms (C₃₈), at most 36 carbon atoms (C₃₆), at most 34 carbon atoms (C₃₄), at most 32 carbon atoms (C₃₂), at most 30 carbon atoms (C₃₀), at most 28 carbon atoms (C₂₈), at most 26 carbon atoms (C₂₆), at most 24 carbon atoms (C₂₄), at most 22 carbon atoms (C₂₂), at most 20 carbon atoms (C₂₀), at most 18 carbon atoms (C₁₈), at most 16 carbon atoms (C₁₆), at most 14 carbon atoms (C₁₄), at most 12 carbon atoms (C₁₂), at most 10 carbon atoms (C₁₀), at most 9 carbon atoms (C₉), at most 8 carbon atoms (C₈), at most 7 carbon atoms (C₇), at most 6 carbon atoms (C₆), at most 5 carbon atoms (C₅), at most 4 carbon atoms (C₄), or at most 3 carbon atoms (C₃). An alkyl group can be branched, straight-chain, or cyclic (e.g., cycloalkyl). An example of an alkyl includes a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be monovalent or multivalent (e.g., bivalent) by removing one or more hydrogens to form appropriate attachment to the parent molecular group. The alkyl group can also be unsubstituted or substituted. For example, the alkyl group can be substituted with one, two, three or, in the case of alkyl groups of two carbons or more, four substituents independently selected from the group consisting of: (1) alkoxy (e.g., —O—R, in which R is alkyl, such as C₁₋₆ alkyl); (2) amino (e.g., —NR¹R², where each of R¹ and R² is, independently, selected from hydrogen, aliphatic, heteroaliphatic, aromatic, as defined herein, or any combination thereof, or R¹ and R², taken together with the nitrogen atom to which each are attached, can form a heterocyclyl group, as defined herein); (3) amido (e.g., —C(O)NR¹R² or —NHCOR¹, where each of R¹ and R² is, independently, selected from hydrogen, aliphatic, heteroaliphatic, aromatic, as defined herein, or any combination thereof, or R¹ and R², taken together with the nitrogen atom to which each are attached, can form a heterocyclyl group, as defined herein); (4) aryl; (5) alkyl; (6) arylalkoxy (e.g., —O-L-R, in which L is alkyl and R is aryl); (7) aryloyl (e.g., —C(O)—R, in which R is aryl); (8) azido (e.g., —N₃); (9) cyano (e.g., —CN); (10) aldehyde (e.g., —C(O)H); (11) C₃₋₈ cycloalkyl; (12) halo (e.g., F, Cl, Br, or I); (13) heterocyclyl (e.g., as defined herein, such as a 5-, 6- or 7-membered ring containing one, two, three, or four non-carbon heteroatoms); (14) heterocyclyloxy (e.g., —O—R, in which R is heterocyclyl, as defined herein); (15) heterocyclyloyl (e.g., —C(O)—R, in which R is heterocyclyl, as defined herein); (16) hydroxyl (e.g., —OH); (17) nitro (e.g., —NO₂); (18) oxo (e.g., ═O); (19) —CO₂R¹, where R¹ is selected from hydrogen, aliphatic, heteroaliphatic, aromatic, as defined herein, or any combination thereof; (20) —C(O)NR¹R², where each of R¹ and R² is, independently, selected from hydrogen, aliphatic, heteroaliphatic, aromatic, as defined herein, or any combination thereof; (21) —SO₂R¹, where R¹ is selected from hydrogen, aliphatic, heteroaliphatic, aromatic, as defined herein, or any combination thereof, and (22) —SO₂NR¹R², where each of R¹ and R² is, independently, selected from hydrogen, aliphatic, heteroaliphatic, aromatic, as defined herein, or any combination thereof. The alkyl group can be a primary, secondary, or tertiary alkyl group substituted with one or more substituents (e.g., one or more halo or alkoxy). In some embodiments, the unsubstituted alkyl group is a C₁₋₃, C₁₋₆, C₁₋₁₂, C₁₋₁₆, C₁₋₁₈, C₁₋₂₀, or C₁₋₂₄ alkyl group.

By “aromatic” is meant a cyclic, conjugated group or moiety of, unless specified otherwise, from 5 to 15 ring atoms having a single ring (e.g., phenyl) or multiple condensed rings in which at least one ring is aromatic (e.g., naphthyl, indolyl, or pyrazolopyridinyl); that is, at least one ring, and optionally multiple condensed rings, have a continuous, delocalized π-electron system. For example, the cyclic, conjugated group or moiety can have at least 5 ring atoms (e.g., at least 6 ring atoms, at least 7 ring atoms, at least 8 ring atoms, at least 9 ring atoms, or at least 10 ring atoms) and/or at most 15 ring atoms (e.g., at most 14 ring atoms, at most 13 ring atoms, at most 12 ring atoms, at most 11 ring atoms, or at most 10 ring atoms). Typically, the number of out of plane π-electrons corresponds to the Huckel rule (4n+2). The point of attachment to the parent structure typically is through an aromatic portion of the condensed ring system. The aromatic group can include one or more heteroatoms (e.g., including but not limited to oxygen, nitrogen, sulfur, silicon, boron, selenium, phosphorous, and oxidized forms thereof within the group, such as in a heteroaromatic group). The aromatic group can also be unsubstituted or substituted (e.g., with one or more substituents described herein for alkyl). The aromatic group can be monovalent or multivalent (e.g., bivalent) by removing one or more hydrogens to form appropriate attachment to the parent molecular group, which can include monovalent or multivalent forms of aromatics (or aryl or arylene) or heteroaromatics (or heteroaryl or heteroarylene).

By “aromatic-aliphatic” is meant an aromatic group that is or can be coupled to a compound disclosed herein, wherein the aromatic group is or becomes coupled through an aliphatic group, as defined herein. In some embodiments, the aromatic-aliphatic group is -L-R, in which L is an aliphatic group, as defined herein, and R is an aromatic group, as defined herein. In some embodiments, the aromatic-aliphatic group is -L-R, in which L is an alkylene group, as defined herein, and R is an aryl group, as defined herein.

By “aryl” is meant an aromatic carbocyclic group comprising at least five carbon atoms to 15 carbon atoms (C₅₋₁₅) and having a single ring or multiple condensed rings. For example, the aromatic carbocyclic group can have at least 5 carbon atoms (C₅) (e.g., at least 6 carbon atoms (C₆), at least 7 carbon atoms (C₇), at least 8 carbon atoms (C₈), at least 9 carbon atoms (C₉), or at least 10 carbon atoms (C₁₀)) and/or at most 15 carbon atoms (C₁₅) (e.g., at most 14 carbon atoms (C₁₄), at most 13 carbon atoms (C₁₃), at most 12 carbon atoms (C₁₂), at most 11 carbon atoms (C₁₁), or at most 10 carbon atoms (C₁₀)). Examples of aryl groups include, but are not limited to, benzyl, naphthalene, phenyl, biphenyl, phenoxybenzene, and the like. The term aryl also includes heteroaryl, which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term non-heteroaryl, which is also included in the term aryl, defines a group that contains an aromatic group that does not contain a heteroatom. The aryl group can be unsubstituted or substituted (e.g., with one or more substituents described herein for alkyl). The aryl group can be monovalent or multivalent (e.g., bivalent) by removing one or more hydrogens to form appropriate attachment to the parent molecular group.

By “cycloalkyl” is meant a monovalent saturated or unsaturated non-aromatic cyclic hydrocarbon group of from three to eight carbons, unless otherwise specified, and is exemplified by cyclopropyl, cyclobutyl, cyclopentyl, cyclohexyl, cycloheptyl, bicyclo[2.2.1.heptyl], and the like. The cycloalkyl group can also be unsubstituted or substituted (e.g., with one or more substituents described herein for alkyl).

By “heteroaliphatic” is meant an aliphatic group, as defined herein, including at least one heteroatom to 20 heteroatoms, which can be selected from, but not limited to oxygen, nitrogen, sulfur, silicon, boron, selenium, phosphorous, and oxidized forms thereof within the group. For example, the aliphatic group can have at least one heteroatom (e.g., at least 2 heteroatoms, at least 3 heteroatoms, at least 4 heteroatoms, at least 5 heteroatoms, at least 6 heteroatoms, at least 7 heteroatoms, at least 8 heteroatoms, at least 9 heteroatoms, at least 10 heteroatoms, at least 11 heteroatoms, or at least 12 heteroatoms) and/or at most 20 heteroatoms (e.g., at most 19 heteroatoms, at most 18 heteroatoms, at most 17 heteroatoms, at most 16 heteroatoms, at most 15 heteroatoms, at most 14 heteroatoms, at most 13 heteroatoms, at most 12 heteroatoms, at most 11 heteroatoms, at most 10 heteroatoms, at most 9 heteroatoms, at most 8 heteroatoms, at most 7 heteroatoms, at most 6 heteroatoms, at most 5 heteroatoms, at most 4 heteroatoms, or at most 3 heteroatoms).

By “heterocyclic” or “heterocyclyl” is meant a 5-, 6- or 7-membered ring, unless otherwise specified, containing one, two, three, or four non-carbon heteroatoms (e.g., independently selected from the group consisting of nitrogen, oxygen, phosphorous, sulfur, or halo). The 5-membered ring has zero to two double bonds and the 6- and 7-membered rings have zero to three double bonds. The term “heterocyclyl” also includes bicyclic, tricyclic and tetracyclic groups in which any of the above heterocyclic rings is fused to one, two, or three rings independently selected from the group consisting of an aryl ring, a cyclohexane ring, a cyclohexene ring, a cyclopentane ring, a cyclopentene ring, and another monocyclic heterocyclic ring, such as indolyl, quinolyl, isoquinolyl, tetrahydroquinolyl, benzofuryl, benzothienyl and the like. Heterocyclics include thiiranyl, thietanyl, tetrahydrothienyl, thianyl, thiepanyl, aziridinyl, azetidinyl, pyrrolidinyl, piperidinyl, azepanyl, pyrrolyl, pyrrolinyl, pyrazolyl, pyrazolinyl, pyrazolidinyl, imidazolyl, imidazolinyl, imidazolidinyl, pyridyl, homopiperidinyl, pyrazinyl, piperazinyl, pyrimidinyl, pyridazinyl, oxazolyl, oxazolidinyl, oxazolidonyl, isoxazolyl, isoxazolidiniyl, morpholinyl, thiomorpholinyl, thiazolyl, thiazolidinyl, isothiazolyl, isothiazolidinyl, indolyl, quinolinyl, isoquinolinyl, benzimidazolyl, benzothiazolyl, benzoxazolyl, furyl, thienyl, thiazolidinyl, isothiazolyl, isoindazoyl, triazolyl, tetrazolyl, oxadiazolyl, uricyl, thiadiazolyl, pyrimidyl, tetrahydrofuranyl, dihydrofuranyl, dihydrothienyl, dihydroindolyl, tetrahydroquinolyl, tetrahydroisoquinolyl, pyranyl, dihydropyranyl, tetrahydropyranyl, dithiazolyl, dioxanyl, dioxinyl, dithianyl, trithianyl, oxazinyl, thiazinyl, oxothiolanyl, triazinyl, benzofuranyl, benzothienyl, and the like. The heterocyclyl group can be unsubstituted or substituted (e.g., with one or more substituents described herein for alkyl). The heterocyclyl group can be monovalent or multivalent (e.g., bivalent) by removing one or more hydrogens to form appropriate attachment to the parent molecular group.

Linkers can include a bond (e.g., a covalent bond); an optionally substituted alkylene; an optionally substituted heteroalkylene (e.g., poly(ethylene glycol), such as —(OCH₂CH₂)—, in which n is an integer of 1 to 100); an optionally substituted arylene; or an optionally substituted heteroarylene. An alkylene can include a multivalent (e.g., bivalent, trivalent, tetravalent, etc.) form of an alkyl group. Examples of alkylene groups include methylene, ethylene, propylene, butylene, etc. For example, the alkylene group can have at least one carbon atom (C₁) (e.g., at least 2 carbon atoms (C₂), at least 3 carbon atoms (C₃), at least 4 carbon atoms (C₄), at least 5 carbon atoms (C₅), at least 6 carbon atoms (C₆), at least 7 carbon atoms (C₇), at least 8 carbon atoms (C₈), at least 10 carbon atoms (C₁₀), at least 12 carbon atoms (C₁₂), at least 14 carbon atoms (C₁₄), at least 16 carbon atoms (C₁₆), at least 18 carbon atoms (C₁₈), or at least 20 carbon atoms (C₂₀)) and/or at most 50 carbon atoms (C₅₀) (e.g., at most 49 carbon atoms (C₄₉), at most 48 carbon atoms (C₄₈), at most 47 carbon atoms (C₄₇), at most 46 carbon atoms (C₄₆), at most 45 carbon atoms (C₄₅), at most 44 carbon atoms (C₄₄), at most 43 carbon atoms (C₄₃), at most 42 carbon atoms (C₄₂), at most 41 carbon atoms (C₄₁), at most 40 carbon atoms (C₄₀), at most 38 carbon atoms (C₃₈), at most 36 carbon atoms (C₃₆), at most 34 carbon atoms (C₃₄), at most 32 carbon atoms (C₃₂), at most 30 carbon atoms (C₃₀), at most 28 carbon atoms (C₂₈), at most 26 carbon atoms (C₂₆), at most 24 carbon atoms (C₂₄), at most 22 carbon atoms (C₂₂), at most 20 carbon atoms (C₂₀), at most 18 carbon atoms (C₁₈), at most 16 carbon atoms (C₁₆), at most 14 carbon atoms (C₁₄), at most 12 carbon atoms (C₁₂), at most 10 carbon atoms (C₁₀), at most 9 carbon atoms (C₉), at most 8 carbon atoms (C₈), at most 7 carbon atoms (C₇), at most 6 carbon atoms (C₆), at most 5 carbon atoms (C₅), at most 4 carbon atoms (C₄), or at most 3 carbon atoms (C₃). The alkylene group can be branched or unbranched. The alkylene group can also be unsubstituted or substituted (e.g., with one or more substituents described herein for alkyl). A heteroalkylene can be an alkylene group containing one, two, three, or four non-carbon heteroatoms (e.g., independently selected from the group consisting of nitrogen, oxygen, phosphorous, sulfur, or halo).

By “salt” is meant an ionic form of a compound or structure (e.g., any formulas, compounds, or compositions described herein), which includes a cation or anion compound to form an electrically neutral compound or structure. For example, non-toxic salts are described in Berge S. M. et al., “Pharmaceutical salts,” J. Pharm. Sci. 1977 January; 66(1):1-19; and in “Handbook of Pharmaceutical Salts: Properties, Selection, and Use,” Wiley-VCH, April 2011 (2nd rev. ed., eds. P. H. Stahl and C. G. Wermuth. The salts can be prepared in situ during the final isolation and purification of the compounds of the invention or separately by reacting the free base group with a suitable organic acid (thereby producing an anionic salt) or by reacting the acid group with a suitable metal or organic salt (thereby producing a cationic salt). Salts can include anionic salts (e.g., halide salts, carbonate salts, sulfate salts, sulfonate salts, phosphate salts, phosphonate salts, and the like) and cationic salts (e.g., metal salts, such as alkali or alkaline earth salts, e.g., barium, calcium lithium, magnesium, potassium, sodium, and the like; other metal salts, such as aluminum, bismuth, iron, and zinc; as well as nontoxic ammonium, quaternary ammonium, and amine cations).

### Dilution Factors

In one or more embodiments, the present disclosure provides a cleaning composition that can be diluted with a solvent (e.g., water) prior to use by up to a factor of 2, or up to a factor of 4, up to factor of 5, or up to a factor of 6, or up to a factor of 8, or up to a factor of 10, or up to a factor of 20, or up to a factor of 50, or up to a factor of 100, or up to a factor or 200, or up to a factor of 400, or up to a factor of 800, or up to a factor of 1000. In other embodiments, the present disclosure provides a point-of-use (POU) composition comprising the above-described cleaning composition, water, and optionally an oxidizer for use on a substrate.

The extent of dilution can depend on the type of POU composition. For example and without limitation, a POU polisher rinse composition can be obtained by diluting a concentrated composition with a solvent (e.g., water) prior to use by up to a factor of 2, or up to a factor of 4, up to factor of 5, or up to a factor of 6, or up to a factor of 8, or up to a factor of 10, or up to a factor of 20, or up to a factor of 50, or up to a factor of 100, or up to a factor or 200, or up to a factor of 400, or up to a factor of 800, or up to a factor of 1000. In some embodiments, the POU polisher rinse composition can be obtained by diluting a concentrated composition with a solvent (e.g., water) prior to use by a factor of at least about 2 (e.g., at least about 3, at least about 4, at least about 5, at least about 6, at least about 7, at least about 8, at least about 9, at least about 10, at least about 12, at least about 14, at least about 16, or at least about 18) to a factor of at most about 200 (e.g., at most about 150, at most about 100, at most about 50, at most about 20, at most about 19, at most about 18, at most about 17, at most about 16, at most about 15, at most about 14, at most about 13, at most about 12, at most about 11, at most about 10, at most about 9 at most about 8, at most about 7, at most about 6, or at most about 5).

A POU post-CMP composition can have a concentration of at least one (e.g., two, three, or more) component, in which its concentration can be compared to a concentration of the corresponding component in a concentrated composition or in a POU polisher rinse composition. For example, and without limitation, if the POU polisher rinse composition is obtained by diluting a concentrated composition by a dilution factor of about 10 (for a 10× diluted polisher rinse composition), then the POU post-CMP composition can be obtained by diluting that same concentrated composition by a dilution factor of about 1000 (for a 1000× diluted post-CMP composition). Alternatively, the POU post-CMP composition can be obtained by diluting a POU polisher rinse composition. For example, and without limitation, if the POU polisher rinse is a 10× diluted polisher rinse composition (as described above), then a 1000× diluted post-CMP composition can be obtained by further diluting the 10× diluted polisher rinse composition by a dilution factor of about 100. Other dilution factors with any cleaning composition (e.g., any described herein) are contemplated.

In another non-limiting example, a POU post-CMP composition can be obtained by diluting a concentrated composition with a solvent (e.g., water) prior to use by up to a factor of 2, or up to a factor of 4, up to factor of 5, or up to a factor of 6, or up to a factor of 8, or up to a factor of 10, or up to a factor of 20, or up to a factor of 50, or up to a factor of 100, or up to a factor or 200, or up to a factor of 400, or up to a factor of 800, or up to a factor of 1000. In some embodiments, the POU post-CMP composition can be obtained by diluting a concentrated composition with a solvent (e.g., water) prior to use by a factor of at least about 50 (e.g., at least about 60, at least about 70, at least about 80, at least about 90, at least about 100, at least about 150, at least about 200, at least about 250, at least about 300, at least about 350, at least about 400, at least about 450) to a factor of at most about 1000 (e.g., at most about 900, at most about 800, at most about 700, at most about 600, at most about 500, at most about 450, at most about 400, at most about 350, at most about 300, at most about 250, at most about 200, at most about 150, or at most about 100).

In some embodiments, a POU post-CMP composition can be obtained by diluting a POU polisher rinse composition with a solvent (e.g., water) prior to use by up to a factor of 2, or up to a factor of 4, up to factor of 5, or up to a factor of 6, or up to a factor of 8, or up to a factor of 10, or up to a factor of 20, or up to a factor of 50, or up to a factor of 100, or up to a factor or 200, or up to a factor of 400, or up to a factor of 500, or up to a factor of 800, or up to a factor of 1000.

Without wishing to be bound by theory, it is believed that the post-CMP composition described herein can include a much smaller concentration/amount of a single chemical material or overall chemical materials, as compared to the polisher rinse composition to be used with the post-CMP composition, and achieve unexpected performance (e.g., better cleaning efficacy, improved defect count or percentage of residue defects, and/or lower corrosion of exposed materials on a substrate) when such a polisher rinse composition and post-CMP composition are used in combination during a cleaning process. Additionally, in some embodiments a polisher rinse composition may include an oxidizer, while a post-CMP composition may not include an oxidizer.

### Exclusions

In one or more embodiments, the cleaning composition (e.g., a concentrated composition, a polisher rinse composition, and/or a post-CMP composition) described herein can optionally include a relatively small amount of abrasive particles. In some embodiments, the abrasive particles can include silica, ceria, alumina, titania, and zirconia abrasives. In some embodiments, the abrasive particles can include nonionic abrasives, surface modified abrasives, or negatively/positively charged abrasives. In some embodiments, the cleaning composition can include abrasive particles in an amount of from at least 0.001% (e.g., at least about 0.005%, at least about 0.01%, at least about 0.05%, or at least about 0.1%) by weight to at most about 0.2% (e.g., at most about 0.15%, at most about 0.1%, at most about 0.05%, or at most about 0.01%) by weight of the cleaning composition described herein. In some embodiments, the cleaning composition described herein can be substantially free of any abrasive particle.

In one or more embodiments, the cleaning composition is substantially free of abrasive particles. As used herein, an ingredient that is “substantially free” from a composition refers to an ingredient that is not intentionally added into the cleaning composition. In some embodiments, the cleaning composition described herein can have at most about 2000 ppm (e.g., at most about 1000 ppm, at most about 500 ppm, at most about 250 ppm, at most about 100 ppm, at most about 50 ppm, at most about 10 ppm, or at most about 1 ppm) of abrasive particles. In some embodiments, the cleaning composition described herein can be completely free of abrasive particles.

In one or more embodiments, the cleaning composition described herein can be substantially free of one or more of certain ingredients, such as organic solvents, pH adjusting agents, quaternary ammonium compounds (e.g., salts such as tetraalkylammonium salts or hydroxides such as tetraalkylammonium hydroxides), alkali bases (such as alkali hydroxides), fluorine containing compounds (e.g., fluoride compounds or fluorinated compounds (e.g., fluorinated polymers/surfactants)), silicon-containing compounds such as silanes (e.g., alkoxysilanes), nitrogen-containing compounds (e.g., amino acids, amines, imines (e.g., amidines such as 1,8-diazabicyclo[5.4.0]-7-undecene (DBU) and 1,5-diazabicyclo[4.3.0]non-5-ene (DBN)), amides, or imides), salts (e.g., halide salts or metal salts), polymers (e.g., nonionic, cationic, anionic, or water-soluble polymers), inorganic acids (e.g., hydrochloric acid, sulfuric acid, phosphoric acid, or nitric acid), surfactants (e.g., cationic surfactants, anionic surfactants, non-polymeric surfactants, or nonionic surfactants), plasticizers, oxidizing agents (e.g., H₂O₂ and/or periodic acid), corrosion inhibitors (e.g., azole or non-azole corrosion inhibitors), electrolytes (e.g., polyelectrolytes), dienoic acids (e.g., sorbic acid), and/or abrasives (e.g., polymeric abrasives, fumed silica, ceria abrasives, nonionic abrasives, surface modified abrasives, negatively/positively charged abrasives, or ceramic abrasive composites). The halide salts that can be excluded from the compositions include alkali metal halides (e.g., sodium halides or potassium halides) or ammonium halides (e.g., ammonium chloride), and can be fluorides, chlorides, bromides, or iodides. As used herein, an ingredient that is “substantially free” from a cleaning composition refers to an ingredient that is not intentionally added into the composition. In some embodiments, the cleaning composition described herein can have at most about 2000 ppm (e.g., at most about 1000 ppm, at most about 500 ppm, at most about 250 ppm, at most about 100 ppm, at most about 50 ppm, at most about 10 ppm, or at most about 1 ppm) of one or more of the above ingredients. In some embodiments, the cleaning composition described herein can be completely free of one or more of the above ingredients.

### Methods

The present disclosure also contemplates a method of using any of the above-described cleaning compositions (e.g., concentrates or POU compositions). With the concentrate, the method can include the steps of diluting the concentrate to form a POU composition (e.g., by a factor of at least two), and then contacting a substrate surface with the POU composition. In some embodiments, an oxidizer can be added to the composition before or after the dilution. In some embodiments, the method can include the step of contacting the substrate surface with the POU composition.

The POU composition can be, for example, any polisher rinse composition or any post-CMP composition described herein. In some embodiments, the POU polisher rinse composition and the POU post-CMP are obtained from a first concentrated composition. In some embodiments, the POU polisher rinse composition is obtained from a first concentrated composition, and the POU post-CMP is obtained from a second concentrated composition. In some embodiments, the first and second concentrated compositions are different. In some embodiments, the first and second concentrated compositions are the same.

In one or more embodiments, this disclosure features a cleaning method that can include contacting a wafer having a surface with a cleaning composition according to the present disclosure (e.g., a concentrated composition, a polisher rinse composition, and/or a post-CMP composition). In some embodiments, the surface can include silicon (Si), silicon nitride (SiN), silicon carbide (SiC), titanium nitride (TiN), tungsten (W), ruthenium (Ru), molybdenum (Mo), silicon oxide (e.g., TEOS), low-K and/or ultra low-k materials (e.g., doped silica and amorphous carbon), copper (Cu), tantalum nitride (TaN), cobalt (Co), polysilicon (p-Si), or a combination of any of these.

In one or more embodiments, this disclosure features a cleaning method that can include contacting a substrate with a cleaning composition according to the present disclosure (e.g., a concentrated composition, a polisher rinse composition, and/or a post-CMP composition).

In one or more embodiments, this disclosure features a cleaning method that can include buffing a substrate (e.g., a polished substrate) with a polisher rinse composition according to the present disclosure to provide a rinse polished substrate; and cleaning the rinse polished substrate with a post-CMP composition according to the present disclosure.

The polisher rinse composition and the post-CMP composition can include same or different components. In some embodiments, the polisher rinse composition includes a plurality of components, and the post-CMP composition includes one or more components of the polisher rinse composition. In some embodiments, the post-CMP composition includes each of the plurality of compositions of the polisher rinse composition. In some embodiments, the post-CMP composition comprises a diluted form of the polisher rinse composition.

The polisher rinse composition and/or the post-CMP composition can include a diluted form of any composition described herein. The post-CMP composition can be a diluted form of the polisher rinse composition. In some embodiments, the post-CMP composition is diluted by any dilution factor described herein (e.g., a dilution factor of up to 500), as compared to the polisher rinse composition. Alternatively, the polisher rinse composition and the post-CMP composition can be diluted forms of a concentrated composition. In some embodiments, the polisher rinse composition includes a first diluted form of a concentrated composition (e.g., by any dilution factor described herein, such as a dilution factor of up to 200), and the post-CMP composition comprises a second diluted form of the concentrated composition (e.g., by any dilution factor described herein, such as a dilution factor of up to 1000).

In buffing or rinse polishing operations, the polisher rinse composition can be applied to the polished substrate in the same way that a CMP composition would have been applied to the previously polished substrate (e.g., the polisher rinse composition is applied while the polished substrate is in contact with a polishing pad). In some embodiments, the conditions can be milder during a buffing process than the conditions used during a CMP process. For example, the down force, rotational speed, or time in a buffing process can be less than the same conditions used in the prior CMP process.

In some embodiments, the down force used in a buffing process is from at least about 5% (e.g., at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, or at least about 75%) to at most about 90% (e.g., at most about 85%, at most about 80%, at most about 75%, at most about 70%, or at most about 65%) of the down force used in a CMP process (e.g., in a preceding CMP process). In one or more embodiments, the down force used in a CMP process is from about 1 psi to about 4 psi. In some embodiments, a polishing pad is brought into contact with the previously polished substrate, but substantially no down force is applied to the previously polished substrate during the rinse polishing process. In some embodiments, the down force used in a buffing process is substantially the same as the down force used in the prior CMP operation.

In some embodiments, the rinse time used in a buffing process is from at least about 10% (e.g., at least about 15%, at least about 20%, at least about 25%, at least about 30%, or at least about 35%) to at most about 50% (e.g., at most about 45%, at most about 40%, at most about 35%, at most about 30%, or at most about 25%) of the rinse time used in a CMP process (e.g., in a preceding CMP process). In one or more embodiments, the rinse time used in a CMP process is from about 2 seconds to about 20 seconds. In some embodiments, the time used in a buffing process is substantially the same as the time used in the prior CMP operation.

In post-CMP operations, a post-CMP composition can be employed in any useful tool (e.g., a cleaning apparatus different from the polishing tool). In post-CMP cleaning applications, the post-CMP composition can be applied in any suitable manner to the substrate to be cleaned. For example, the post-CMP composition can be used with a large variety of conventional cleaning tools and techniques (e.g., brush scrubbing, spin rinse dry, etc.). In some embodiments, a cleaning tool or apparatus suitable for a post-CMP cleaning process is a tool (e.g., a brush scrubber or a spin rinse dryer) without polishing equipment (e.g., a polishing pad, a polishing platen, and/or a polishing head).

In some embodiments, the cleaning method can further include (e.g., prior to buffing) polishing a substrate with a CMP composition to form the polished substrate. In some embodiments, said polishing and said buffing are performed in a same polishing tool. In some embodiments, the cleaning composition can be applied on a wafer surface for on-platen buffing of wafers on a Reflexion polisher or other polishing tool to remove defectivity by buffing the wafer on a soft pad in presence of the cleaning composition on the polishing pad. In some embodiments, said cleaning is performed in a post-CMP tool (e.g., a brush scrubber or a spin rinse dryer). In some embodiments, the cleaning composition can be applied on a wafer surface in the brush box or the megasonic or other post-CMP tool for a time ranging from about 5 seconds to about 10 minutes (e.g., from about 15 seconds to 5 minutes) at a temperature in the range of about 20° C. to about 60° C.

In some embodiments, the cleaning method can further include (e.g., prior to buffing and/or cleaning): diluting a concentrated composition to form at least one of the polisher rinse composition and the post-CMP composition. The concentrated composition can be diluted by any useful dilution factor (e.g., by any dilution factor described herein, such as from about 5 to about 1000).

In one or more embodiments, this disclosure features a cleaning method that can include applying a cleaning composition according to the present disclosure (e.g., a concentrated composition, a polisher rinse composition, and/or a post-CMP composition) to a surface of a substrate (e.g., a wafer, which may optionally be a polished substrate or a polished wafer); and bringing a pad into contact with the surface of the substrate and moving the pad in relation to the substrate. In some embodiments, the cleaning composition is a polisher rinse composition, and the cleaning method provides a rinse polished substrate.

In some embodiments, after the rinse polishing or buffing process, the substrate can be removed from the polishing tool and subjected to a post-CMP cleaning by contacting the rinse polished substrate with a cleaning composition in a post-CMP cleaning tool (e.g., a brush scrubber or a spin rinse dryer). In some embodiments, the cleaning composition is a post-CMP composition, and the cleaning method provides a post-CMP processed substrate.

Further, in some embodiments, before rinse polishing or buffing a substrate with a polisher rinse composition described herein, the substrate can undergo a polishing process in the presence of a polishing composition. In some embodiments, the polishing composition includes all the components of the cleaning composition described herein and further includes one or more abrasives. In some embodiments, the polishing composition is applied to a substrate in the polishing tool, and the pad of the polishing tool is brought into contact with the substrate and moved in relation to the substrate to create a polished substrate. Then, the polished substrate may be cleaned by applying a cleaning composition described herein (e.g., a polisher rinse composition and/or a post-CMP composition).

In some embodiments, the method that uses a cleaning composition described herein can further include producing a semiconductor device from the substrate treated by the cleaning composition through one or more steps. For example, CMP, photolithography, ion implantation, dry/wet etching, plasma ashing, deposition (e.g., PVD, CVD, ALD, ECD), wafer mounting, die cutting, packaging, and testing can be used to produce a semiconductor device from the substrate treated by the cleaning composition described herein.

### Characteristics

As applied to post-CMP cleaning operations, the cleaning compositions described herein can be usefully employed to remove contaminants present on a substrate surface after a CMP processing step. In one or more embodiments, the contaminants causing defectivity can be at least one selected from the group consisting of abrasives, particles, organic residues, polishing byproducts, slurry byproducts, slurry induced organic residues, inorganic polished substrate residues, pad debris, and polyurethane residue, etc. In one or more embodiments, the cleaning compositions of the present disclosure can be employed to remove organic residues constituted by organic particles which are insoluble in water and thus remain on the wafer surface post the CMP polishing step. In other embodiments, the cleaning compositions of the present disclosure can be employed to remove abrasive residues/particles and/or polishing byproducts, and reduce scratches that cause defectivity on the wafer surface post the CMP polishing step.

Without wishing to be bound by theory, it is believed that the organic particles are generated from polishing composition components, which deposit on a substrate surface after polishing, and are insoluble and thus remain as contaminants on the wafer surface. The presence of these contaminants causes defect counts on the wafer surface. These defect counts, when analyzed on a Defect measuring tool (such as the AIT-XUV tool from KLA Company) provide the total defect counts (TDC) that is a sum of all the individual defect counts. In one or more embodiments, the cleaning compositions described herein remove from at least about 30% (e.g., at least about 50%, at least about 75%, at least about 80%, at least about 90%, at least about 95%, at least about 98%, at least about 99%, at least about 99.5%, or at least about 99.9%) to at most about 100% of the total defect counts (TDC) remaining on a substrate surface after the post-CMP process.

Without wishing to be bound by theory, it is believed that the cleaning compositions herein, when used as a polisher rinse composition and as a post-CMP composition, provides an unexpected reduction in certain types of defects, such as defects characterized by presence of residue on a surface of the substrate. In one or more embodiments, the cleaning compositions described herein remove from at least about 30% (e.g., at least about 50%, at least about 75%, at least about 80%, at least about 90%, at least about 95%, at least about 98%, at least about 99%, at least about 99.5%, or at least about 99.9%) to at most about 100% of the total defect counts (TDC) arising from residue that are remaining on a substrate surface after the post-CMP process.

Without wishing to be bound by theory, it is believed that there is a surprising and unexpected synergism with the components of the cleaning compositions described herein. For example, the organic acids can reduce scratches and solubilize metal oxide and/or silica containing residues (e.g., abrasive residues on a wafer) that can cause scratching, the amino acids (if present) can serve as corrosion inhibitors for metals (e.g., tungsten and/or molybdenum), the anionic polymer is an excellent solubilizer for hydrophobic organic residues left on a substrate surface after a CMP process, and the nonionic surfactant is effective for cleaning hydrophobic surfaces to improve defects on various substrates. Further, it is believed that the combination of a tricarboxylic organic acid (e.g., citric acid) and a dienoic acid (e.g., sorbic acid), optionally along with an amino acid (e.g., histidine or glycine) and an anionic polymer, shows significant reduction in metal galvanic corrosion, which is key to improving the yield of substrates cleaned after a CMP process.

In one or more embodiments, the cleaning compositions disclosed herein may be used to polish, buff, and/or post-CMP clean a semiconductor substrate that include at least a tungsten portion and/or a molybdenum portion. In some non-limiting embodiments, the substrate may include at least tungsten and silicon oxide and/or silicon nitride and/or polysilicon portions. In some non-limiting embodiments, the substrate may include at least molybdenum and silicon oxide and/or silicon nitride and/or polysilicon portions.

In one or more embodiments, the cleaning compositions described herein (e.g., polisher rinse composition and/or post-CMP composition) may provide relatively low static etch rates (SER) for metals, particularly tungsten and/or molybdenum, while not significantly decreasing their removal rates. The ability to lower the SER is important as it may reduce defects and other undesirable outcomes from occurring during a polishing process.

In one or more embodiments, the static etch rate (SER) for a tungsten or molybdenum sample incubated with a cleaning composition for 5 minutes at 45° C. according to the present disclosure is less than about 5 Å/min, or less than about 4 Å/min, or less than about 3 Å/min, or less than about 2 Å/min, or less than about 1 Å/min, or less than about 0.8 Å/min, or less than about 0.6 Å/min, or less than about 0.5 Å/min, or less than about 0.4 Å/min.

The specific examples below are to be construed as merely illustrative, and not limitative of the remainder of the disclosure in any way whatsoever. Without further elaboration, it is believed that one skilled in the art can, based on the description herein, utilize the present invention to its fullest extent.

### EXAMPLES

Examples are provided to further illustrate the capabilities of the polisher rinse compositions, post-CMP compositions, and methods of the present disclosure. The provided examples are not intended and should not be construed to limit the scope of the present disclosure. Any percentages listed are by weight (wt %) unless otherwise specified. The anionic polymers described in the examples were obtained from a variety of suppliers and may, in some instances, include minor differences in carbon chain lengths and molecular weights. The examples shown herein are representative and cannot encompass the complete broad scope of this invention disclosure.

The general cleaning compositions (e.g., polisher rinse and post-CMP compositions) used in the examples are shown in Table 1 below. The specifics details on the differences in the compositions tested will be explained in further detail when discussing the respective examples.

TABLE 1

| Component | % By Weight of Composition |
|---|---|
| Organic acid | 0.00001-50 |
| Amino acid | 0.00001-50 |
| Anionic polymer | 0.00001-50 |
| Nonionic surfactant | 0.00001-1 |
| Solvent (DI Water) | 60-99.99 |
| pH adjuster | 0.00001-10 (if used) |
| pH | 1-6.5 |
| Biocide | 1-1000 ppm |

### Example 1: Demonstration of Defectivity Reduction for Polisher Rinse Compositions Used with Post-CMP Cleaning Compositions on Silicon

In this Example, the effect of the polisher rinse composition on defectivity reduction on silicon was determined. The general cleaning process included polishing with CMP Slurry Composition 1 (CMP Slurry Comp. 1) including an abrasive, buffing on the same platen as used during polishing, and post-CMP cleaning. In particular, a diluted form of Polisher Rinse Composition 1 (Polisher Rinse Comp. 1) was used during post-CMP cleaning.

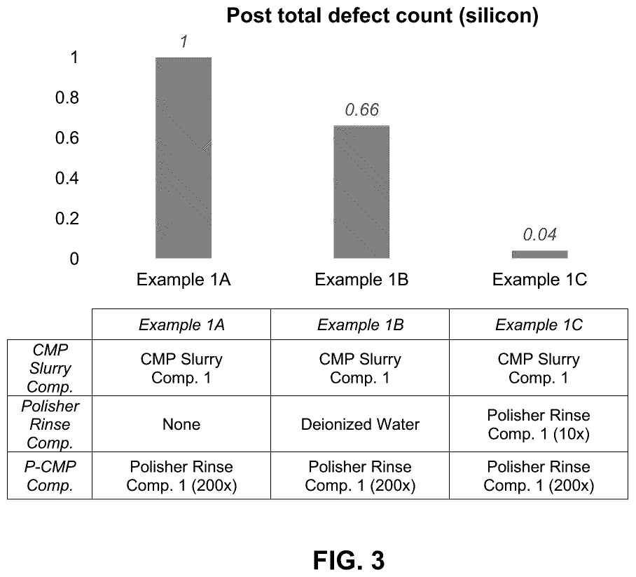

Modifications to the general process are provided in the table of FIG. 3. A first condition (Example 1A in FIG. 3) including use of CMP Slurry Comp. 1 during polishing and use of 200× diluted Polisher Rinse Comp. 1 during post-CMP cleaning. A second condition (Example 1B in FIG. 3) including use of CMP Slurry Comp. 1 during polishing, use of deionized water during buffing, and use of 200× diluted Polisher Rinse Comp. 1 during post-CMP cleaning. A third condition (Example 1C in FIG. 3) including use of CMP Slurry Comp. 1 during polishing, use of 10× diluted Polisher Rinse Comp. 1 during buffing, and use of 200× diluted Polisher Rinse Comp. 1 during post-CMP cleaning. As can be seen in the results provided in FIG. 3, use of Polisher Rinse Comp. 1 during both buffing and post-CMP cleaning resulted in significantly lower defectivity after the post-CMP process. For example, Example 1B provided about 34% reduction in defects (as compared to Example 1A) when using DI water during buffing and using Polisher Rinse Comp. 1 during post-CMP cleaning. In another example, Example 1C provided about 96% reduction in defects (as compared to Example 1A) when using Polisher Rinse Comp. 1 during both buffing and post-CMP clean.

### Example 2: Demonstration of Defectivity Reduction for Polisher Rinse Compositions Used with Post-CMP Cleaning Compositions on Polysilicon

In this Example, the effect of the polisher rinse composition on defectivity reduction on polysilicon was determined. The general cleaning process included polishing with CMP Slurry Composition 2 (CMP Slurry Comp. 2) including an abrasive, buffing on the same platen as used during polishing, and post-CMP cleaning. In particular, a diluted form of Polisher Rinse Composition 1 (Polisher Rinse Comp. 1) was used during post-CMP cleaning. For comparison, Comparative Polisher Rinse Comp. 1 was also employed. In this Example, CMP Slurry Comp. 2 was acidic, and Comparative Polisher Rinse Comp. 1 was alkaline.

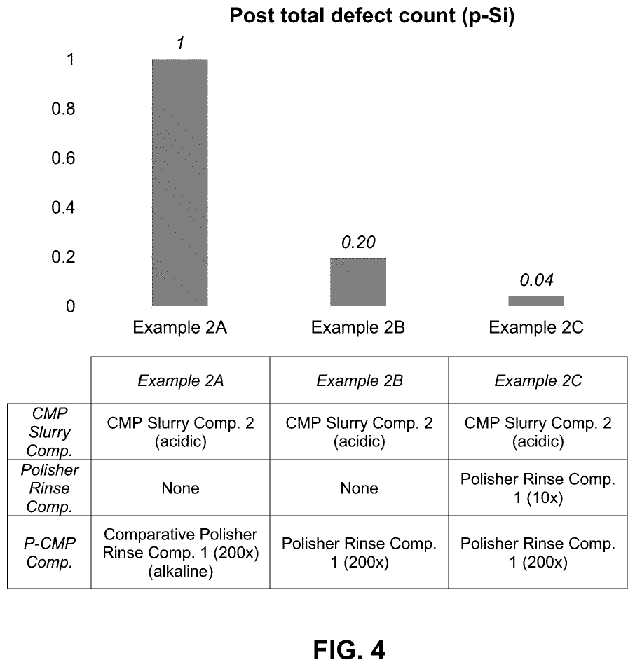

Modifications to the general process are provided in the table of FIG. 4. A first condition (Example 2A in FIG. 4) including use of CMP Slurry Comp. 2 during polishing and use of 200× diluted Comparative Polisher Rinse Comp. 1 during post-CMP cleaning. A second condition (Example 2B in FIG. 4) including use of CMP Slurry Comp. 2 during polishing and use of 200× diluted Polisher Rinse Comp. 1 during post-CMP cleaning. As can be seen, use of Polisher Rinse Comp. 1 (even at the same dilution as Comparative Polisher Rinse Comp. 1) provided improved defectivity (about 80% reduction in defects) after the post-CMP process.

A third condition (Example 2C in FIG. 4) including use of CMP Slurry Comp. 2 during polishing, use of 10× diluted Polisher Rinse Comp. 1 during buffing, and use of 200× diluted Polisher Rinse Comp. 1 during post-CMP cleaning. As can be seen in the results provided in FIG. 4, use of Polisher Rinse Comp. 1 during both buffing and post-CMP cleaning resulted in significantly lower defectivity after the post-CMP process. For example, Example 2C provided about 96% reduction in defects (as compared to Example 2A) when using Polisher Rinse Comp. 1 during both buffing and post-CMP clean.

### Example 3: Demonstration of Reduction in Residue Defects for Polisher Rinse Compositions Used with Post-CMP Cleaning Compositions on Polysilicon

In this Example, the types of defects present after post-CMP cleaning was classified on polysilicon. The general cleaning process included polishing with CMP Slurry Composition 2 (CMP Slurry Comp. 2) including an abrasive, buffing, and post-CMP cleaning. In particular, a diluted form of Polisher Rinse Composition 1 (Polisher Rinse Comp. 1) was used during post-CMP cleaning.

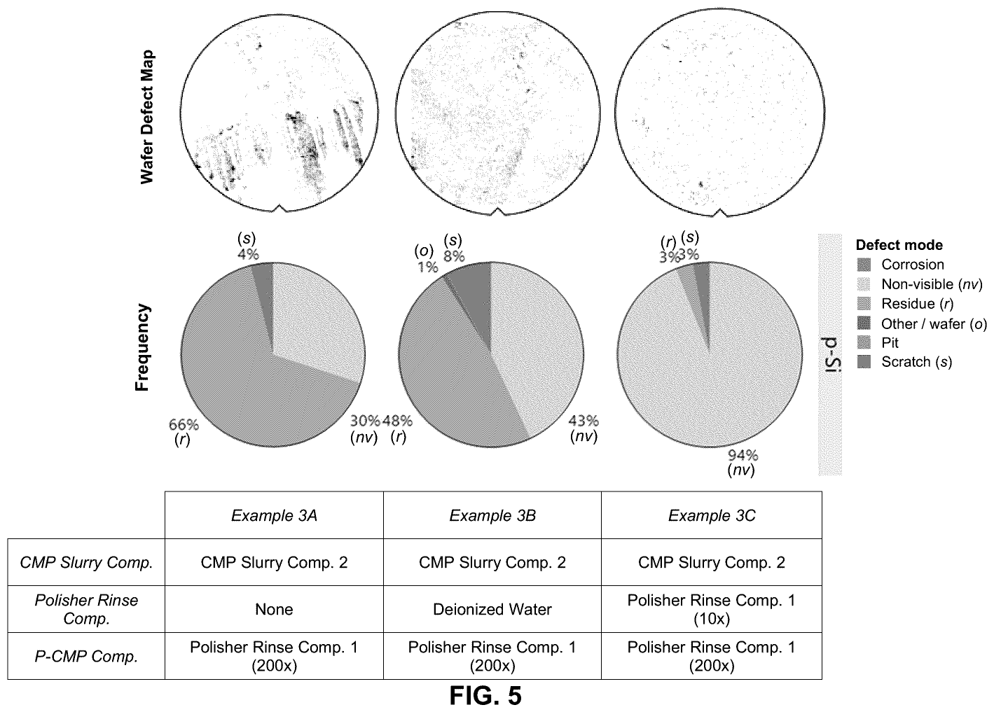

Modifications to the general process are provided in the table of FIG. 5. A first condition (Example 3A in FIG. 5) including use of CMP Slurry Comp. 2 during polishing and use of 200× diluted Polisher Rinse Comp. 1 during post-CMP cleaning. A second condition (Example 3B in FIG. 5) including use of CMP Slurry Comp. 2 during polishing, use of deionized water during buffing, and use of 200× diluted Polisher Rinse Comp. 1 during post-CMP cleaning. A third condition (Example 3C in FIG. 5) including use of CMP Slurry Comp. 2 during polishing, use of 10× diluted Polisher Rinse Comp. 1 during buffing, and use of 200× diluted Polisher Rinse Comp. 1 during post-CMP cleaning. As can be seen in the results provided in FIG. 5, use of Polisher Rinse Comp. 1 during both buffing and post-CMP cleaning resulted in significantly lower percentage of residue defects (e.g., from 66% to 3%) after the post-CMP process. Furthermore, the majority of classified defects under the third condition included non-visible defects.

### Example 4: Demonstration of Defectivity Reduction for Polisher Rinse Compositions Used with Post-CMP Cleaning Compositions on Dielectric

In this Example, the effect of the polisher rinse composition on defectivity reduction on TEOS or SiN was determined. The general cleaning process included polishing with CMP Slurry Composition 3 (CMP Slurry Comp. 3) including an abrasive, buffing on a second platen, and post-CMP cleaning. In particular, a diluted form of Polisher Rinse Composition 2 (Polisher Rinse Comp. 2) was used during post-CMP cleaning.

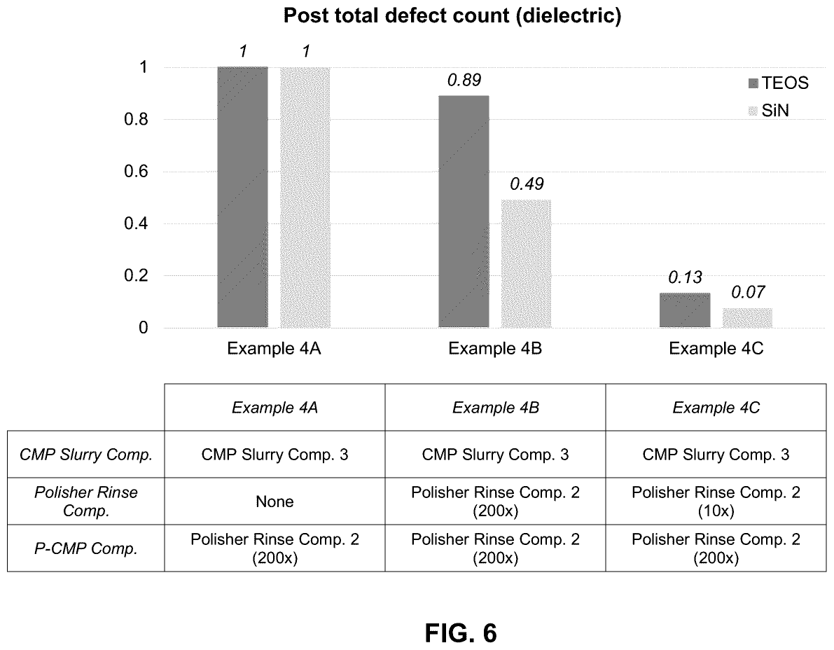

Modifications to the general process are provided in the table of FIG. 6. A first condition (Example 4A in FIG. 6) including use of CMP Slurry Comp. 3 during polishing and use of 200× diluted Polisher Rinse Comp. 2 during post-CMP cleaning. A second condition (Example 4B in FIG. 6) including use of CMP Slurry Comp. 3 during polishing, use of 200× diluted Polisher Rinse Comp. 2 during buffing, and use of 200× diluted Polisher Rinse Comp. 2 during post-CMP cleaning. A third condition (Example 4C in FIG. 6) including use of CMP Slurry Comp. 3 during polishing, use of 10× diluted Polisher Rinse Comp. 2 during buffing, and use of 200× diluted Polisher Rinse Comp. 2 during post-CMP cleaning. As can be seen in the results provided in FIG. 6, use of Polisher Rinse Comp. 2 during both buffing and post-CMP cleaning resulted in lower defectivity after the post-CMP process. For example, Example 4B provided about 11% reduction in defects for TEOS and about 51% reduction in defects for SiN (as compared to Example 4A) when using 200× diluted Polisher Rinse Comp. 1 during both buffing and post-CMP clean.

Furthermore, use of a more concentrated form of Polisher Rinse Comp. 2 during buffing and a more dilute form of Polisher Rinse Comp. 2 during post-CMP cleaning resulted in significantly lower defectivity after the post-CMP process for both TEOS and SiN. For example, Example 4C provided about 87% reduction in defects for TEOS and about 93% reduction in defects for SiN (as compared to Example 4A) when using 10× diluted Polisher Rinse Comp. 1 during buffing and using 200× diluted Polisher Rinse Comp. 1 during post-CMP clean.

Although the present invention is defined in the claims, it should be understood that the present invention can also (alternatively) be defined in accordance with the following embodiments:

Embodiment 1. A method for cleaning a substrate, comprising: buffing a polished substrate with a polisher rinse composition to provide a rinse polished substrate, wherein the polisher rinse composition comprising a plurality of components; and cleaning the rinse polished substrate with a post-CMP composition, wherein the post-CMP composition comprises one or more components of the polisher rinse composition.

Embodiment 2. The method of embodiment 1, wherein the post-CMP composition comprises a diluted form of the polisher rinse composition.

Embodiment 3. The method of embodiment 2, wherein the post-CMP composition is diluted by a dilution factor of up to 500, as compared to the polisher rinse composition.

Embodiment 4. The method of embodiment 1, wherein the polisher rinse composition comprises a first diluted form of a concentrated composition, and wherein the post-CMP composition comprises a second diluted form of the concentrated composition.

Embodiment 5. The method of embodiment 4, wherein the polisher rinse composition is diluted by a dilution factor of up to 200, as compared to the concentrated composition; and/or wherein the post-CMP composition is diluted by a dilution factor of up to 1000, as compared to the concentrated composition.

Embodiment 6. The method of embodiment 1, wherein the polisher rinse composition and the post-CMP composition is substantially free of abrasive particles.

Embodiment 7. The method of embodiment 6, wherein a pH value of each of the polisher rinse composition and the post-CMP composition is, independently, from about 1 to about 6.5.

Embodiment 8. The method of embodiment 6, wherein the post-CMP composition comprises the same plurality of components as the polisher rinse composition.

Embodiment 9. The method of embodiment 8, wherein the post-CMP composition comprises a dilution factor of up to about 500, as compared to the polisher rinse composition.

Embodiment 10. The method of embodiment 1, further comprising:

polishing a substrate with a CMP composition to form the polished substrate.

Embodiment 11. The method of embodiment 10, wherein the polisher rinse composition has a difference in pH value that is no more than about ±3, as compared to the pH value of the CMP composition; and/or wherein the post-CMP composition has a difference in pH value that is no more than about ±3, as compared to the pH value of the CMP composition.

Embodiment 12. The method of embodiment 10, wherein said polishing and said buffing are performed in a same polishing tool.

Embodiment 13. The method of embodiment 12, wherein said cleaning is performed in a post-CMP tool.

Embodiment 14. The method of embodiment 1, further comprising:

diluting a concentrated composition to form at least one of the polisher rinse composition and the post-CMP composition.

Embodiment 15. The method of embodiment 14, wherein the concentrated composition is diluted by a dilution factor from about 5 to about 1000.

Embodiment 16. The method of embodiment 14, wherein the concentrated composition comprising the cleaning composition of embodiment 1.

Embodiment 17. The method of embodiment 16, wherein the polisher rinse composition comprises a first diluted form of the cleaning composition of embodiment 1.

Embodiment 18. The method of embodiment 17, wherein the first diluted form has a difference in pH value that is no more than about ±3, as compared to the pH value of the concentrated composition.

Embodiment 19. The method of embodiment 17, wherein the first diluted form comprises a dilution factor of up to 200, as compared to the concentrated composition.

Embodiment 20. The method of embodiment 16, wherein the post-CMP composition comprises a second diluted form of the cleaning composition of claim 1.

Embodiment 21. The method of embodiment 20, wherein the second diluted form has a difference in pH value that is no more than about ±3, as compared to the pH value of the concentrated composition.

Embodiment 22. The method of embodiment 20, wherein the second diluted form comprises a dilution factor of up to 1000, as compared to the concentrated composition.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A cleaning composition comprising:
at least one organic acid;
at least one anionic polymer;
at least one nonionic surfactant; and
water.

2. The composition of claim 1, wherein the at least one organic acid is selected from the group consisting of formic acid, acetic acid, malonic acid, citric acid, propionic acid, malic acid, adipic acid, succinic acid, aspartic acid, ascorbic acid, lactic acid, oxalic acid, hydroxyethylidene diphosphonic acid, 2-phosphono-1,2,4-butane tricarboxylic acid, aminotrimethylene phosphonic acid, hexamethylenediamine tetra(methylenephosphonic acid), bis(hexamethylene)triamine phosphonic acid, amino acetic acid, peracetic acid, potassium acetate, phenoxyacetic acid, benzoic acid, amino carboxylic acid, glycine, bicine, diglycolic acid, glyceric acid, tricine, alanine, histidine, valine, phenylalanine, proline, glutamine, aspartic acid, glutamic acid, arginine, lysine, tyrosine, and mixtures thereof.

3. The composition of claim 1, wherein the at least one organic acid is in an amount of from about 0.00001% to about 50% by weight of the composition.

4. The composition of claim 1, wherein the at least one organic acid comprises a polycarboxylic acid and an amino acid.

5. The composition of claim 1, wherein the at least one anionic polymer is formed from one or more monomers selected from the group consisting of (meth)acrylic acid, maleic acid, acrylic acid, acrylamide, malic acid, methacrylic acid, vinyl phosphonic acid, vinyl sulfonic acid, allyl sulfonic acid, styrene sulfonic acid, acrylamide, acrylamidopropyl sulfonic acid, phosphonic acid, phosphoric acid, vinyl phosphoric acid, butadiene/maleic acid, caprolactam, etherimide, 2-ethyl-2-oxazoline, N-iso-propylacrylamide, sodium phosphinite, and co-formed products thereof, and sodium, potassium, and ammonium salts thereof.

6. The composition of claim 1, wherein the at least one anionic polymer comprises poly(4-styrenylsulfonic) acid (PSSA), polyacrylic acid (PAA), poly(vinylphosphonic acid) (PVPA), poly(2-acrylamido-2-methyl-1-propanesulfonic acid), poly(N-vinylacetamide) (PNVA), anionic poly(methyl methacrylate) (PMMA), anionic polyacrylamide (PAM), polyaspartic acid (PASA), anionic poly(ethylene succinate) (PES), anionic polybutylene succinate (PBS), poly(vinyl alcohol) (PVA), 2-propenoic acid copolymer with 2-methyl-2-((1-oxo-2-propenyl)amino)-1-propanesulfonic acid monosodium salt and sodium phosphinite, 2-propenoic acid copolymer with 2-methyl-2-((1-oxo-2-propenyl)amino)-1-propanesulfonic acid monosodium salt and sodium hydrogen sulfite sodium salt, 2-acrylamido-2-methyl-1-propanesulfonic acid-acrylic acid copolymer, poly(4-styrenesulfonic acid-co-acrylic acid-co-vinylphosphonic acid) terpolymer, or a mixture thereof.

7. The composition of claim 1, wherein the at least one anionic polymer comprises poly(4-styrenylsulfonic) acid (PSSA), polyacrylic acid (PAA), poly(vinylphosphonic acid) (PVPA), poly(2-acrylamido-2-methyl-1-propanesulfonic acid), poly(N-vinylacetamide) (PNVA), anionic poly(methyl methacrylate) (PMMA), anionic polyacrylamide (PAM), 2-acrylamido-2-methyl-1-propanesulfonic acid-acrylic acid copolymer, poly(4-styrenesulfonic acid-co-acrylic acid-co-vinylphosphonic acid) terpolymer, or a mixture thereof.

8. The composition of claim 1, wherein the at least one anionic polymer is in an amount of from about 0.00001% to about 50% by weight of the cleaning composition.

9. The composition of claim 1, wherein the at least one nonionic surfactant is selected from the group consisting of polyoxyalkylene alkyl ether (e.g., polyoxyethylene stearyl ether), polyoxyalkylene alkenyl ether (e.g., polyoxyethylene oleyl ether), polyoxyethylene alkyl phenyl ether (e.g., polyoxyethylene nonyl phenyl ether), polyoxyalkylene glycol (e.g., polyoxypropylene polyoxyethylene glycol), polyoxyalkylene monoalkylate (monoalkyl fatty acid ester polyoxyalkylene) (e.g., polyoxyethylene monoalkylates such as polyoxyethylene monostearate and polyoxyethylene monooleate), polyoxyalkylene dialkylate (dialkyl fatty acid ester polyoxyalkylene) (e.g., polyoxyethylene dialkylates such as polyoxyethylene distearate and polyoxyethylene dioleate), bispolyoxyalkylene alkylamide (e.g., bispolyoxyethylene stearylamide), sorbitan fatty acid ester or polyoxyethylene sorbitan fatty acid ester (e.g., polysorbate), polyoxyethylene alkylamine, glycerine fatty acid ester, oxyethylene-oxypropylene block copolymer, acetylene glycol-based surfactant, acetylene-based polyoxyethylene oxide, and mixtures thereof.

10. The composition of claim 1, wherein the at least one nonionic surfactant is in an amount of from about 0.00001% to about 1% by weight of the cleaning composition.

11. The composition of claim 1, wherein the pH of the composition is from about 1 to about 6.5.

12. The composition of claim 1, wherein the composition has an acidic pH.

13. The composition of claim 1, further comprising an organic base as a pH adjuster.

14. The composition of claim 13, wherein the organic base is selected from the group consisting of tris(hydroxymethyl)aminomethane, tetrabutylammonium hydroxide, ethyltrimethylammonium hydroxide, tetrapropylammonium hydroxide, tetraethylammonium hydroxide, tetramethylammonium hydroxide, diethyldimethylammonium hydroxide, dimethyldipropylammonium hydroxide, benzyltrimethylammonium hydroxide, tris (2-hydroxyethyl) methylammonium hydroxide tetramethylphosphonium hydroxide, tetraethylphosphonium hydroxide, tetrapropylphosphonium hydroxide, tetrabutylphosphonium hydroxide, tetrapentylphosphonium hydroxide, triethyl-methyl-phosphonium hydroxide, tetrakis(hydroxymethyl)phosphonium hydroxide, tetraphenylphosphonium hydroxide, and mixtures thereof.

15. The composition of claim 13, wherein the organic base is in an amount from about 0.00001% to about 10% by weight of the cleaning composition.

16. The composition of claim 1, wherein the composition does not include a dienoic acid.

17. The composition of claim 1, wherein the composition is substantially free of abrasive particles.

18. A cleaning composition comprising:
at least one carboxylic acid;
at least one amino acid;
at least one anionic polymer;
at least one nonionic surfactant;
an optional dienoic acid;
an optional pH adjuster; and
water.

19. The composition of claim 18, wherein the composition has an acidic pH.

20. A method for cleaning a cleaning a substrate, comprising:
contacting the substrate having a surface comprising Si, SiN, Sic, TiN, W, Ru, Mo, TEOS, Cu, TaN, Co, or p-Si with the cleaning composition of claim 1.

21. The method of claim 1, wherein
the substrate is a wafer surface comprising Si, SiN, SiC, TiN, W, Ru, Mo, TEOS, Cu, TaN, Co, or p-Si.
